(19) United States
(12) Patent Application Publication
(10) Pub. No.: US 2025/0050524 A1
(43) Pub. Date: Feb. 13, 2025

(54) BODY HAIR SHAVER, SYSTEM AND METHOD

(71) Applicant: Peter Gegg, Belize City (BZ)

(72) Inventor: Peter Gegg, Belize City (BZ)

(21) Appl. No.: 18/685,294

(22) PCT Filed: Sep. 28, 2022
(86) PCT No.: PCT/IB2022/059208

§ 371 Date: Feb. 21, 2024

(30) Foreign Application Priority Data
Sep. 28, 2022 (WO) PCT/IB22/59208

(51) Int. Cl. B26B 21/40; B26B 21/52

(52) U.S. Cl. CPC B26B 21/4012; B26B 21/521

(57) ABSTRACT

The present disclosure is directed to a body hair shaver having a one-piece housing operationally configured to receive and hold one or more removable blade members for one or more shaving activities. The one-piece housing comprises one or more moveable parts that may be directed between an open position for inserting and removing one or more blade members in and out from the housing and a closed position for holding the one or more blade members in the housing during operation of the body hair shaver.

### CROSS-REFERENCE TO RELATED APPLICATIONS

This application is the U.S. National Phase of International Application No. PCT/IB2022/059208 (filed Sep. 28, 2022). This International Application claims the priority and benefit of U.S. Prov. Pat. App. Ser. No. 63/249,458 (filed Sep. 28, 2021). Both the U.S. Provisional and International Applications identified are hereby incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

This disclosure relates generally to a body hair shaver device.

### Background of the Invention

In the field of body hair shaving, shaving blade edge performance typically relates to the angle and distance of the surface of a shaving blade edge as the shaving blade edge contacts a person's skin. Because wet shave razor cartridges are constructed of various individual component parts, the ability to reproduce consistent blade edges of a particular shave geometry requires quality control and expense. Non-limiting examples of known wet shave razor cartridges constructed of various individual component parts include U.S. Patent No. 9,687,988 B2, titled “Functional Razor Cartridge,” issued on Jun. 27, 2017; U.S. Pat. No. 8,782,903 B2, titled “Shaving Razor Comb Guard for a Trimming Blade,” issued on Jul. 22, 2014; U.S. Pat. No. 10,843,356 B2, titled “Razor Cartridge,” issued on Nov. 24, 2020; U.S. Pat. No. 8,567,068 B2, titled “Safety Razors,” issued on Oct. 29, 2013; U.S. Pat. No. 5,426,851, titled “Safety Razors,” issued on Jun. 27, 1995: each of which is herein incorporated by reference in its entirety.

Unfortunately, a fixed shave geometry of a wet shave razor cartridge limits the usefulness of a razor cartridge to a particular shave type, for example, (1) a razor cartridge constructed for very aggressive shaving useful in trimming hair, (2) a razor cartridge constructed for very mild shaving useful for common leg hair and facial hair shaving. In addition, the construction of known wet shave razor cartridges typically results in clogged shaved hair debris between and/or around the one or more razor blades of a particular wet shave razor cartridge that is not easy to simply rinse away via a water stream.

Overcoming the above shortcomings is desired.

### SUMMARY OF THE INVENTION

The present disclosure is directed to a body hair shaver comprising a one-piece housing configured to hold one or more blade members, the one-piece housing comprising one or more resilient mouths; wherein each of the one or more resilient mouths is moveable between an open position for passage of a blade member of the one or more blade members and a closed position for holding the blade member in a hair cutting position.

The present disclosure is also directed to a body hair shaver assembly comprising a one-piece housing, one or more blade members, a handle in releasable attachment with the one-piece housing, the one-piece housing including (1) one or more resilient clip members moveable between an open position and a closed position; and (2) one or more slots for holding one or more blade members in a hair cutting position.

The present disclosure is also directed to a method comprising shaving with a body hair shaver including a one-piece housing configured to hold one or more blade members, the one-piece housing comprising a resilient mouth moveable between an open position for passage of the one or more blade members and a closed position for holding the one or more blade members in a hair cutting position.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a front perspective view of a one-piece housing of a hair shaver of the present disclosure.

FIG. 2 is a rear perspective view of the one-piece housing of FIG. 1.

FIG. 3 is a side perspective partial phantom view of the one-piece housing of FIG. 1.

FIG. 4 is a sectional side perspective view of the one-piece housing of FIG. 1.

FIG. 5 is a side view of the one-piece housing of FIG. 1 in a closed position.

FIG. 6 is a side view of the one-piece housing of FIG. 1 in an open position.

FIG. 7 is a side view of a hair shaver including the one-piece housing of FIG. 1 and a blade member housed within the one-piece housing.

FIG. 8 is a sectional side view of the hair shaver of FIG. 7.

FIG. 9 is a front perspective view of the hair shaver of FIG. 7.

FIG. 10 is a rear perspective view of the hair shaver of FIG. 7.

FIG. 11 is a front view of the hair shaver of FIG. 7.

FIG. 12 is another side view of the one-piece housing of FIG. 1.

FIG. 13 is a detail view of the one-piece housing of FIG. 12.

FIG. 14 is detail view of another embodiment of the one-piece housing of FIG. 12.

FIG. 15 is detail view of another embodiment of the one-piece housing of FIG. 12.

FIG. 16 is a sectional side perspective view of the one-piece housing of FIG. 1.

FIG. 17 is a detail view of the one-piece housing of FIG. 16.

FIG. 18 is a side view of the one-piece housing of FIG. 1.

FIG. 19 is a side view of the one-piece housing of FIG. 1.

FIG. 20 is a front perspective view of another embodiment of a hair shaver including a one-piece housing.

FIG. 21 is a rear perspective view of the hair shaver of FIG. 20.

FIG. 22 is a front perspective view of another embodiment of a hair shaver including a one-piece housing.

FIG. 23 is a front view of the hair shaver of FIG. 22.

FIG. 24 is a rear perspective view of the hair shaver of FIG. 22.

FIG. 25 is a rear perspective view of another embodiment of a hair shaver including a one-piece housing.

FIG. 26 is a side view of the hair shaver of FIG. 25.

FIG. 27 is a side view of the one-piece housing of the hair shaver of FIG. 25.

FIG. 28 is front perspective view of the hair shaver of FIG. 25.

FIG. 29 is a front perspective view of an embodiment of an adjustable hair shaver including a one-piece housing and an adjustable member adjustably secured to the one-piece housing.

FIG. 30 is a side view of the adjustable hair shaver of FIG. 29.

FIG. 31 is a rear perspective view of the adjustable hair shaver of FIG. 29.

FIG. 32 is a perspective view of an embodiment of an actuation member of the adjustable hair shaver of FIG. 29.

FIG. 33 is a front perspective view of the one-piece housing of the adjustable hair shaver of FIG. 29.

FIG. 34 is a rear perspective view of the adjustable member of the hair shaver of FIG. 29.

FIG. 35 is a rear perspective view of an embodiment of an adjustable hair shaver including a one-piece housing and an adjustable member adjustably secured to the one-piece housing.

FIG. 36 is a front perspective view of the adjustable hair shaver of FIG. 35.

FIG. 37 is a front perspective view of the one-piece housing of the adjustable hair shaver of FIG. 35.

FIG. 38 is a front perspective view of the adjustable member of the adjustable hair shaver of FIG. 35.

FIG. 39 is a front perspective view of the adjustable hair shaver of FIG. 35.

FIG. 40 is a detail view of the adjustable hair shaver of FIG. 39.

FIG. 41 is a side view of an embodiment of a hair shaver of the present disclosure.

FIG. 42 is a perspective view of an embodiment of an adjustable hair shaver of the present disclosure.

FIG. 43 is a perspective view of an embodiment of a hair shaver including a handle coupler.

FIG. 44 is a perspective view of the hair shaver of FIG. 43.

FIG. 45 is a perspective view of an embodiment of an adjustable hair shaver including a handle coupler.

FIG. 46 is a perspective view of the adjustable hair shaver of FIG. 45.

FIG. 47 is a side perspective view of an embodiment of a one-piece housing including a handle coupler.

FIG. 48 is a perspective view of the one-piece housing of FIG. 47.

FIG. 49 is a side view of an embodiment of a one-piece housing of the present disclosure in an open position.

FIG. 50 is a side perspective view of the one-piece housing of FIG. 49 in a closed position.

FIG. 51 is a side view of an embodiment of a one-piece housing of the present disclosure in an open position.

FIG. 52 is a side perspective view of an embodiment of a one-piece housing of a hair shaver including a handle coupler with the one-piece housing in an open position.

FIG. 53 is a perspective view of the one-piece housing of FIG. 52 in a closed position.

FIG. 54 is a side perspective view of an embodiment of a one-piece housing of a hair shaver including a handle coupler with the one-piece housing in an open position.

FIG. 55 is a perspective view of the one-piece housing of FIG. 54 in a closed position.

FIG. 56 is a perspective partial view of the one-piece housing of FIG. 54.

FIG. 57 is side perspective view of an embodiment of a one-piece housing of a hair shaver including a handle coupler with the one-piece housing in an open position.

FIG. 58 is a perspective view of the one-piece housing of FIG. 57 in an open position.

FIG. 59 is a perspective view of the one-piece housing of FIG. 57 in a closed position.

FIG. 60 is a partial side view of the one-piece housing of FIG. 57 in a closed position.

FIG. 61 is a front perspective view of a hair shaver including the one-piece housing of FIG. 57.

FIG. 62 is a side perspective view of an embodiment of a one-piece housing of a hair shaver including a handle coupler with the one-piece housing in an open position.

FIG. 63 is a side perspective view of the one-piece housing of FIG. 62 in a closed position.

FIG. 64 is a perspective view of the one-piece housing of FIG. 62 in an open position.

FIG. 65 is a perspective view of the one-piece housing of FIG. 62.

FIG. 66 is a perspective view of a one-piece housing of a hair shaver including a handle coupler with the one-piece housing in an open position.

FIG. 67 is a partial perspective view of the one-piece housing of FIG. 66 in an open position.

FIG. 68 is a perspective view of the one-piece housing of FIG. 66 in a closed position.

FIG. 69 is a perspective view of an embodiment of a one-piece housing of a hair shaver in a closed position.

FIG. 70 is an illustration of cut body hair cut at a first length relative the skin surface of an individual.

FIG. 71 is an illustration of cut body hair cut at a second length relative the skin surface of an individual.

FIG. 72 is an illustration of cut body hair cut at a third length relative the skin surface of an individual.

FIG. 73 is an illustration of cut body hair cut at a fourth length relative the skin surface of an individual.

FIG. 74 is an illustration of an alternate embodiment of a hair shaver.

FIG. 75 is another illustration the embodiment of a hair shaver depicted in FIG. 74.

FIG. 76 is an illustration of the alternate embodiment of a hair shaver depicted in FIG. 74.

FIG. 77 is a partial perspective view of the one-piece housing of FIG. 74 in an closed position.

FIG. 78 is a partial perspective view of the one-piece housing of FIG. 74 in an open position.

FIG. 79 is a partial perspective view of the one-piece housing of FIG. 74 in an closed position.

FIG. 80 is a partial perspective view of the one-piece housing of FIG. 74 in an open position.

FIG. 81 is a partial perspective view of the one-piece housing of FIG. 74 in an closed position.

FIG. 82 is a partial perspective view of the one-piece housing of FIG. 74 in an open position.

FIG. 83 is an illustration of an alternate embodiment of a hair shaver.

FIG. 84 is another illustration the embodiment of a hair shaver depicted in FIG. 83.

FIG. 85 is an illustration of the alternate embodiment of a hair shaver depicted in FIG. 83.

FIG. 86 is a perspective view of a screw.

FIG. 87 is a partial perspective view of the one-piece housing of FIG. 83 in an closed position.

FIG. 88 is a partial perspective view of the one-piece housing of FIG. 83 in an open position.

FIG. 89 is a partial perspective view of the one-piece housing of FIG. 83 in an open position.

FIG. 90 is a rear perspective view of the adjustable member of the hair shaver of FIG. 83.

FIG. 91 is a rear perspective view of the adjustable member of the hair shaver of FIG. 83.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within +20% of the stated value. In other embodiments, the value is within +15% of the stated value. In other embodiments, the value is within +10% of the stated value. In other embodiments, the value is within +7.5% of the stated value. In other embodiments, the value is within +5% of the stated value. In other embodiments, the value is within +2.5% of the stated value. In other embodiments, the value is within +1% of the stated value.

The term “substantially” or “essentially” means that a value of a given quantity is within ±10% of the stated value. In other embodiments, the value is within +7.5% of the stated value. In other embodiments, the value is within +5% of the stated value. In other embodiments, the value is within +2.5% of the stated value. In other embodiments, the value is within #1% of the stated value. In other embodiments, the value is within +0.5% of the stated value. In other embodiments, the value is within +0.1% of the stated value.

### DETAILED DESCRIPTION OF PROFFERED EMBODIMENTS

For the purposes of promoting an understanding of the principles of the disclosure, reference is now made to the embodiments illustrated in the drawings and particular language will be used to describe the same. It is understood that no limitation of the scope of the claimed subject matter is intended by way of the disclosure. As understood by one skilled in the art to which the present disclosure relates, various changes and modifications of the principles as described and illustrated are herein contemplated.

It is also to be understood that the terminology used herein is for the purpose of describing particular embodiments only, and is not intended to be limiting. As used in this disclosure, the phrases “blade” and “blade member” may be used interchangeably to refer to an elongated shaving blade with a cutting edge at its front, a blade end at its rear, a tapered portion leading to the cutting edge and a uniform thickness portion extending from the blade end at the rear to the tapered portion. The term “individual” may refer to humans and/or other mammals for which the present invention is directed for use. Herein, a “shaving area” refers to a location on an individual's skin where body hair (or “hair”) growing out there from is maintained at one or more desired lengths. The terms “treat” and “shave” refer to cutting or otherwise removing body hair from a shaving area. The phrases “wet razor” and “wet shaver” are often used interchangeably by persons of ordinary skill in the art and may be used interchangeably in this disclosure. Herein, a “desired shave” for a particular individual includes a shaving activity that produces cut hair of a shaving area having a desired length. A hair shaver of this disclosure comprising a single blade member may be referred to as a “single blade hair shaver.” A hair shaver of this disclosure comprising a plurality of blade members may be referred to as a “multi-blade hair shaver.”

In one embodiment, the disclosure provides a device such as a hand-held body hair shaver for removing or trimming an unwanted length of hair from one or more target shaving areas. The body hair shaver may be provided as a disposable shaver as the term is commonly understood in the field of wet shavers. The body hair shaver may also be provided with replaceable blade members. The body hair shaver may also be provided as an adjustable hair shaver operationally configured to adjust a useable length of a cutting edge of one or more blade members for shaving purposes.

In another embodiment, the disclosure provides a body hair wet shaver including a razor cartridge including a one-piece housing construction that is operationally configured to receive and hold one or more blade members during operation. The one or more blade members may be removed and/or replaced from the one-piece housing as desired.

In another embodiment, the disclosure provides a body hair shaver comprising a one-piece housing configured to hold one or more blade members, the one-piece housing comprising a resilient mouth moveable between an open position for passage of the one or more blade members and a closed position for holding the one or more blade members in a hair cutting position.

In another embodiment, the disclosure provides a body hair shaver comprising a body hair shaver comprising a one-piece housing including (1) one or more resilient clip members moveable between an open position and a closed position; and (2) one or more slots for holding one or more blade members in a hair cutting position.

One particularly advantageous feature of the present disclosure includes a body hair shaver having a one-piece cartridge or one-piece housing operationally configured to receive and hold one or more removable blade members for one or more shaving activities. Various non-limiting embodiments of a body hair shaver having a one-piece housing effective to provide a desired shave are discussed below.

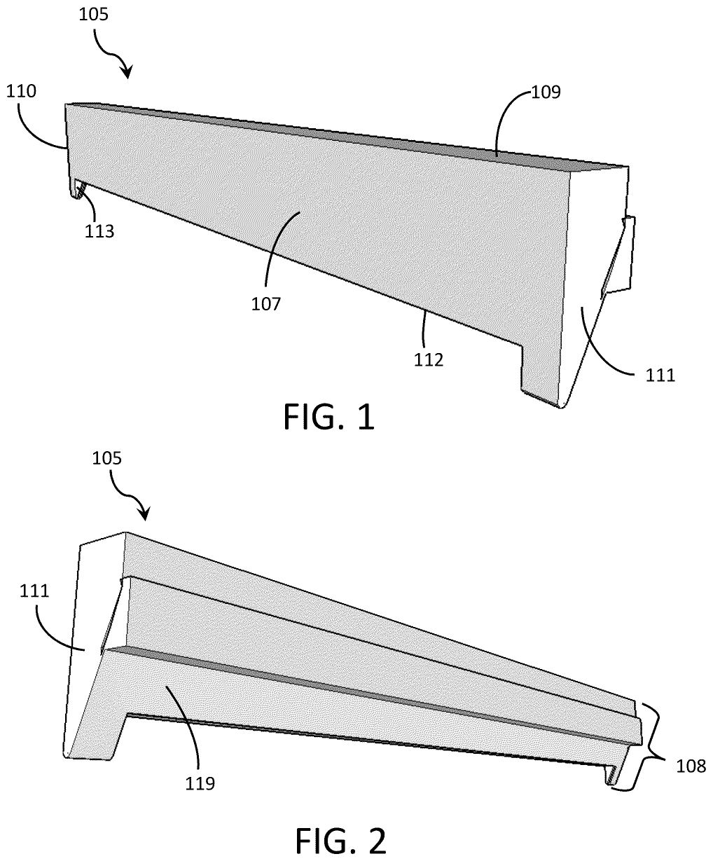

In one embodiment as shown in FIGS. 1-19, a body hair shaver (hereafter “hair shaver 100”) of this disclosure may include a one-piece housing 105 operationally configured to receive and hold at least a single blade member 200 at a position within the housing 105 effective to provide a desired shave as defined above. Here, a one-piece housing 105 may include a front portion 107, a rear portion 108, an upper portion 109, a left side portion 110, a right side portion 111, a bottom portion 112 and an angled slot 113 for receiving a blade member 200 within the housing 105. As shown, the front portion 107, i.e., the front surface of the housing 105, includes a planar surface operationally configured as a contact surface against an individual's skin during shaving operations. In another embodiment, the front portion 107 may include a non-planar surface as desired or as otherwise required for one or more shaving operations. In another embodiment, the front portion 107 may include one or more lubricating strips as known in the art of wet shavers. In the embodiment as shown, the upper portion 109, the left side portion 110 and the right side portion 111 also comprise planar surfaces, although one or more non-planar surfaces may be employed. Examples of non-planar surfaces useable with the housing 105 include, but are not necessarily limited to curved surfaces, tapered surfaces, angled surfaces, dimpled surfaces, uneven surfaces, and combinations thereof.

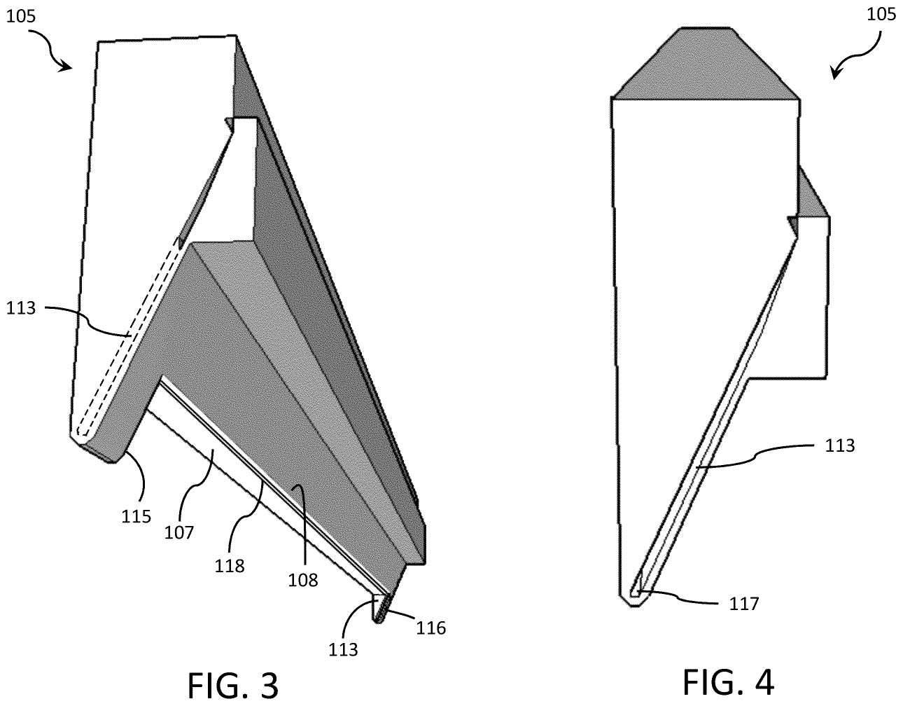

With reference to FIGS. 3-4, a bottom portion 112 of the housing 105 comprises part of the front portion 107 and part of the rear portion 108. For example, part of the front portion 107 and the rear portion 108 form blade stops 115, 116 (or “blade retainers 115, 116”) of the bottom portion 112, each having a catch surface 117 at a lowermost part of opposing ends of the slot 113 operationally configured as abutment surfaces for opposing ends of a cutting edge 210 of a blade member 200 that is housed in the slot 113. In addition, an elongated edge of the front portion 107 and an elongated edge of rear portion 108 disposed between the opposing blade stops 115, 116 face to form an elongated linear opening 118 there between for receiving part of a cutting edge 210 of a blade member 200 there through according to the location of the catch surfaces 117 within the blade stops 115, 116. The width of the opening 118 may vary according to the dimensions of the corresponding blade member 200 whereby a wider opening 118 allows for a greater length of a tapered portion leading to the cutting edge 210 to be exposed out through the opening 118.

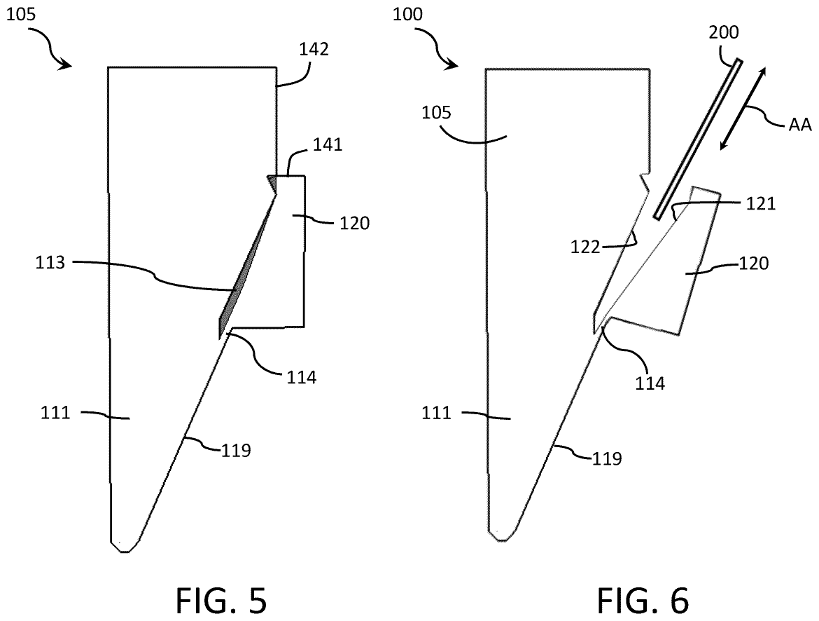

With reference to FIGS. 5-8, part of the rear portion 108 of the housing 105 includes at least one clip member 120 operationally configured to be directed between a closed position as shown in FIG. 5 and an open position as shown in FIG. 6. Suitably, the rear portion 108 of the housing 105 includes a resilient part 114 (or “flexible part 114”) disposed between a lower face 119 of the rear portion 108 and the clip member 120 operationally configured to flex or bend in a manner effective to bias the clip member 120 to an open position as shown in FIG. 6. Referring to FIG. 5, a clip member 120 may include an upper surface 141 extending out from the uppermost part 142 of the rear portion 108 of the housing 30) 105 a distance effective for an individual to direct the clip member 120 to an open position using his/her finger and/or hand held tool and/or other instrument.

When the clip member 120 is set at an open position, an inner surface 121 of the clip member 120 and an inner surface 122 of the housing 105 form a resilient mouth type configuration exposing the slot 113 for passage of a blade member 200, e.g., for inserting a blade member 200 into the slot 113 and for removing a blade member 200 from the slot 113 (see directional arrow AA in FIG. 6). As such, a slot 113 of this disclosure comprises two opposing openings: (1) opening 118, and (2) the mouth type configuration opening formed by the inner surface 121 of the clip member 120 and an inner surface 122 of the housing 105.

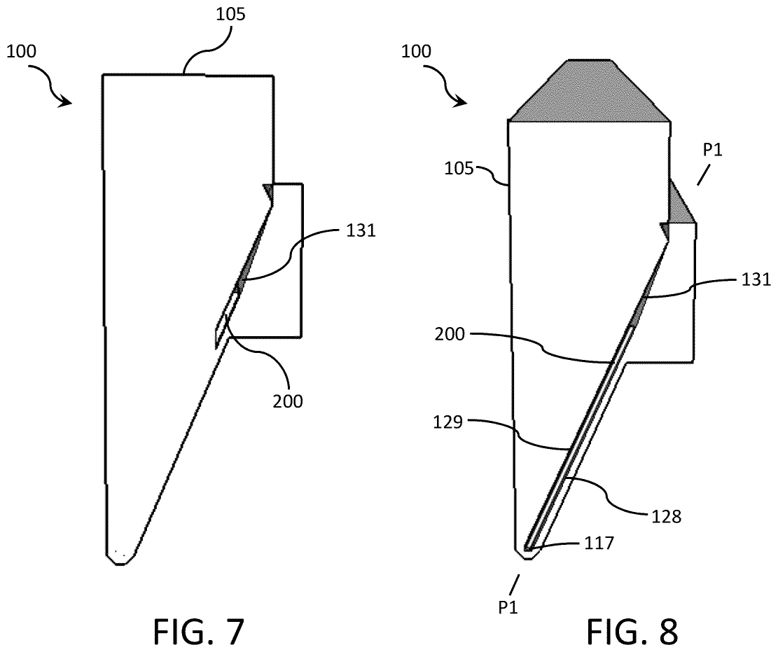

As shown in FIGS. 7-11, when the clip member 120 is set to a closed position, the slot 113 suitably includes inner dimensions, e.g., width, length, depth, effective for receiving and holding at least part of the blade member 200 in a snug or close-fitting operable position to produce a desired shave. Although a housing 105 of this disclosure may be built to scale, in one embodiment the housing 105 comprises a slot 113 with inner dimensions effective for receiving and holding a blade member 200 having dimensions as shown in Table 1 in a snug or close-fitting operable position.

TABLE 1
Width from Cutting Edge 210 to Blade End: of or about 3.0 mm
(0.12 inches);
Length of Cutting Edge 210: of or about 37.0 mm (1.46 inches);
Uniform thickness at Blade End: of or about 0.1 mm (0.004 inches).

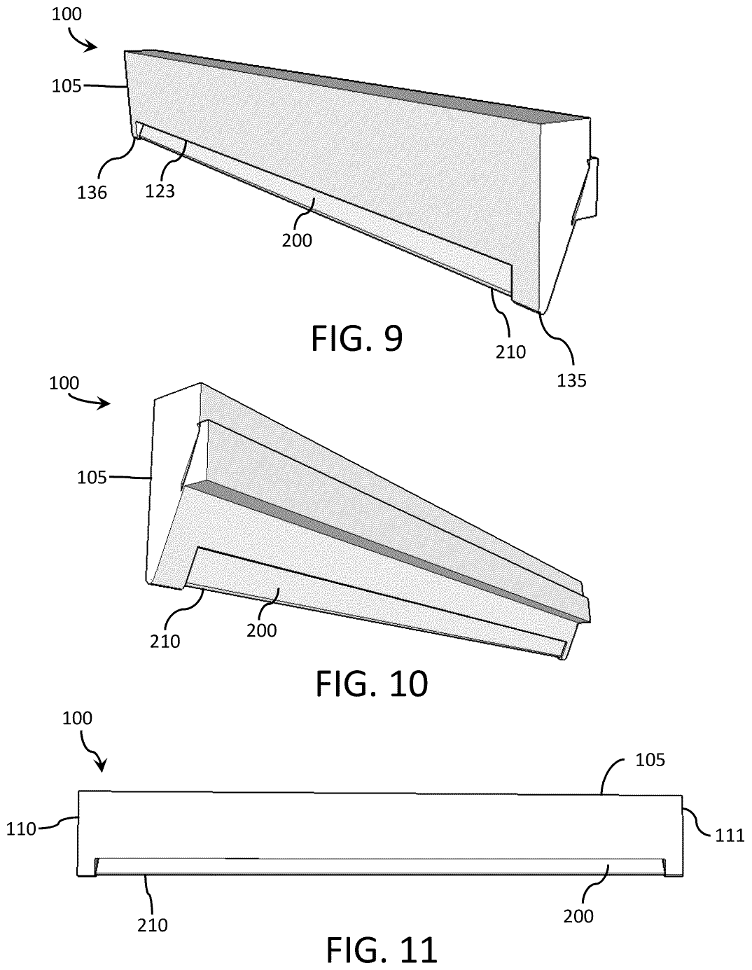

Referring to FIG. 9, the length of the exposed cutting edge 210 (see FIG. 9) of a blade member 200 as described in Table 1 includes a length of or about 34.0 mm (1.34 inches).

As shown in FIG. 8, the inner surface of the slot 113 is operationally configured to maintain a blade member 200 lengthwise at an angle within the housing 105 along a plane (see plane P1) effective to orient a cutting edge 210 of the blade member 200 to produce a desired shave, e.g., a mild shave, a medium shave, an aggressive shave. Accordingly, in this disclosure the angle of the slot 113 within the housing 105, i.e., the angle of opposing inner surfaces 128 and 129 of the slot 113, may vary to provide a desired shave.

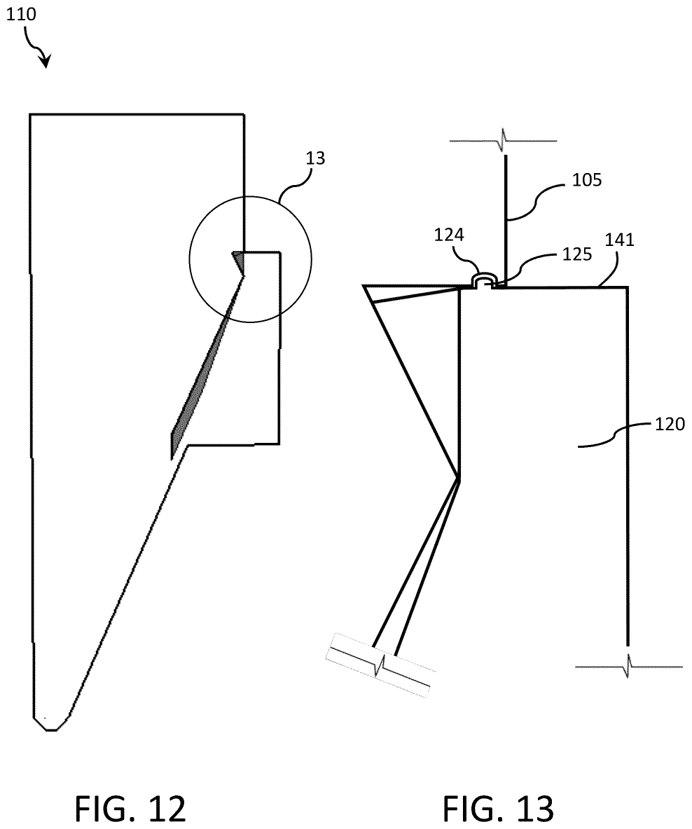

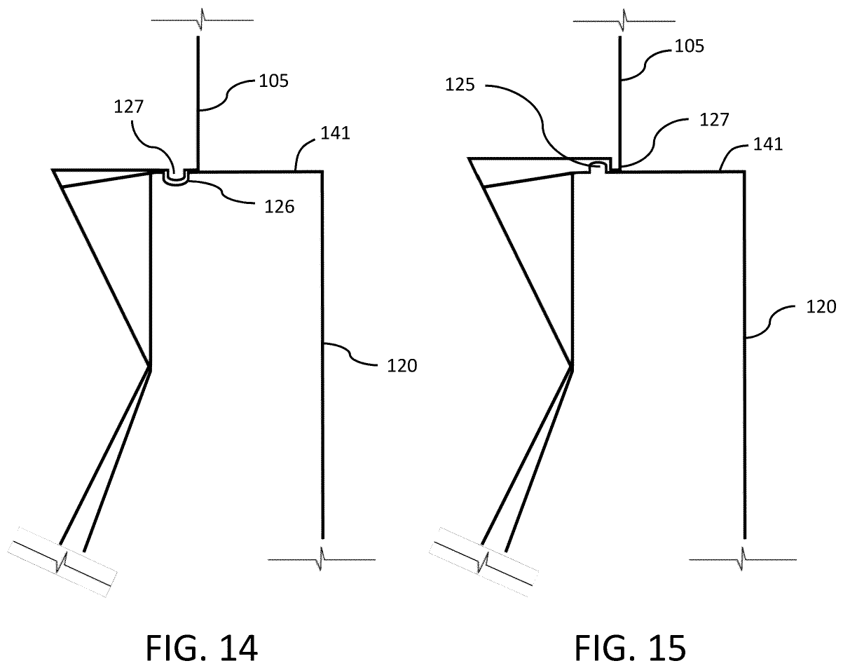

Turning to FIGS. 12 and 13, the housing 105 is operationally configured to maintain the clip member 120 in a closed position during operation of the hair shaver 100 via a snap-in locking system comprising (1) an elongated groove 124 of a predetermined depth disposed along the rear portion 108 of the housing 105 from the left side portion 110 to the right side portion 111 and (2) a corresponding raised member 125 disposed along the upper surface 141 of the clip member 120 from the left side portion 110 to the right side portion 111 operationally configured to mate with the groove 124 as shown. In another embodiment, the clip member 120 may comprise an elongated groove 126 on the upper surface 141 and the rear portion 108 of the housing 105 may comprise a corresponding elongated raised member 127 for mating with the elongated groove (see FIG. 14). In another embodiment, the clip member 120 and the rear portion 108 of the housing 105 may each comprise a raised member suitable for holding the clip member 120 in a closed position during operation of the hair shaver 100 (see FIG. 15).

As depicted in FIG. 7, at a closed position the inner surface 121 of the clip member 120 and the inner surface 122 of the housing 105 form an upper portion 131 of the slot 113 that is exposed along the left side portion 110 and right side portion 111 of the housing 105 whereby a portion of a blade member 200, e.g., a uniform thickness portion of a blade member 200, may be visible when the blade member 200 is set within the slot 113. In other words, when the clip member 120 is set to a closed position the slot 113 formed has a depth greater than the length of the blade member 200 so that when the blade member 200 is set within the slot 113 at an abutment position with the opposing blade stops 115, 116 an upper portion 131 of the slot 113 remains open or void from the left side portion 110 to the right side portion 111. Suitably, the opening through the upper portion 131 of the slot 113 allows for water and/or other fluid to flow through the housing 105 in one or more directions for purposes of cleaning of the hair shaver 100, e.g., rinsing away shaved hair debris and/or shaving cream, foam, or gel from the hair shaver 100 via water flow such as running water from a faucet: rinsing away shaved hair debris and/or shaving cream, foam, or gel from the hair shaver 100 via soaking and/or agitation of the hair shaver 100 in a container of water and/or other fluid.

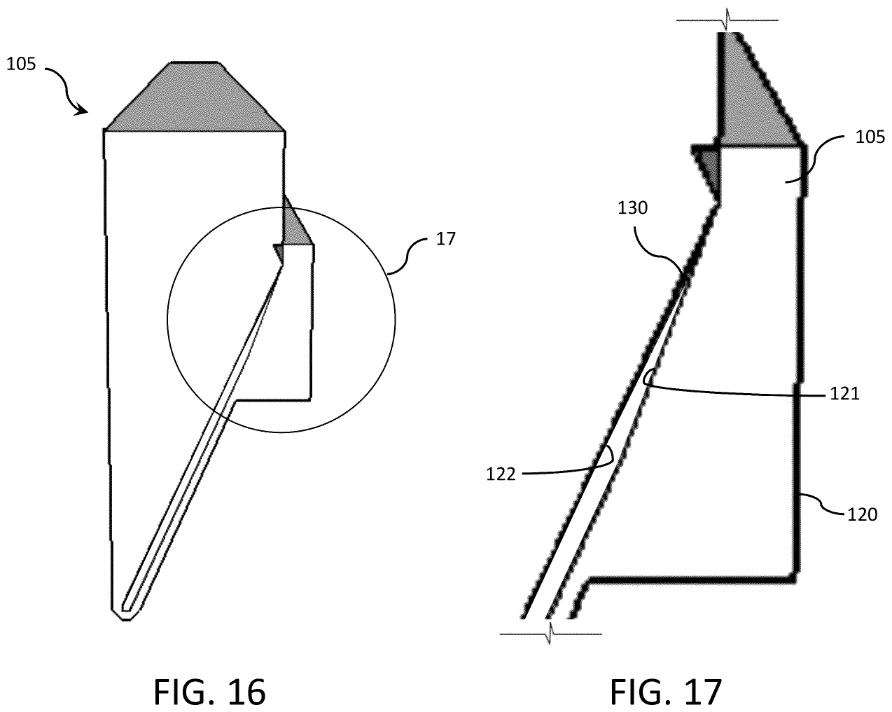

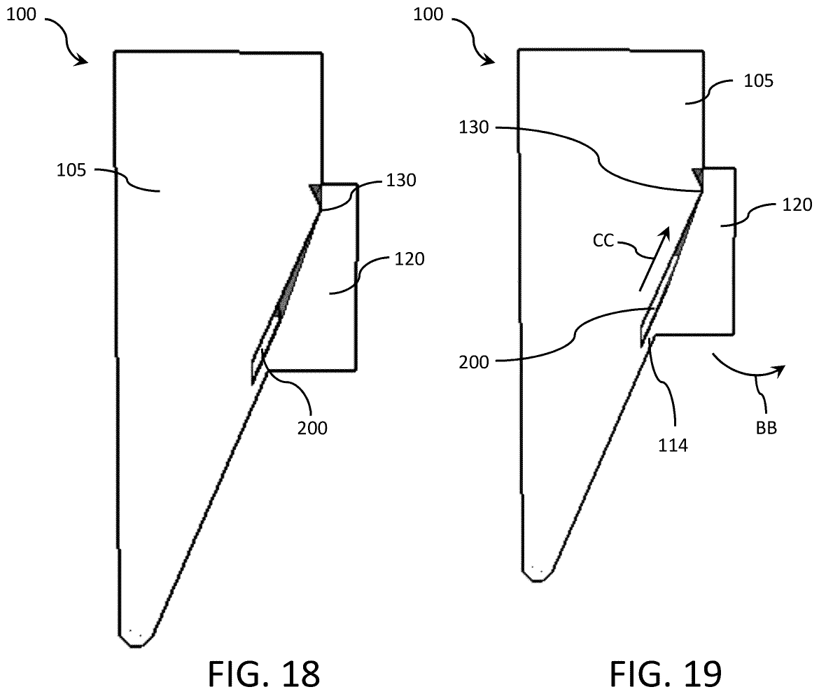

Turning to FIGS. 16-19, in one embodiment the inner surface 121 of the clip member 120 forming part of the upper portion 131 of the slot 113 may include a non-planar surface tapering inward toward the inner surface 122 of the housing 105 forming a closed proximal end 130 of the slot 113. Suitably, the tapering inner surface 121 is operationally configured to direct a blade member 200 to a desired location within the slot 113 as the clip member 120 is being set to a closed position. Also, during operation of the hair shaver 100, the combination of the flexible part 114 and the tapering inner surface 121 produce a resilient clip member 120 operationally configured to be directed apart from the inner surface 122 angularly (see directional arrow BB in FIG. 19) in response to linear movement of the blade member 200 within the slot 113 toward the closed proximal end 130 (see directional arrow CC in FIG. 19). For example, during use of the hair shaver 100 an individual may contact the cutting edge 210 of the blade member 200 against his/her skin with enough pressure to force the blade member 200 to move linearly within the slot 113 toward the closed proximal end 130 whereby the blade member 200 directs the clip member 120 angularly apart from the inner surface 122 a number of degrees according to the flexibility and/or bendability of the flexible part 114. Suitably, the narrowing of the slot 113 toward the closed proximal end of the slot 113 produces an increased resiliency of the clip member 120 (also referred to herein as “clip member 120 resiliency”) effective to direct the blade member 200 back to an abutment position with the opposing blade stops 115, 116 once the hair shaver 100 is removed from the individual's skin or once less pressure is applied to the cutting edge 210 of the blade member 200.

Suitably, the flexibility and/or bendability and/or resiliency of the flexible part 114 of the rear portion 108 of the housing 105 may depend on the one or more materials of construction of the housing 105 and/or the length of the flexible part 114 and/or the thickness of the flexible part 114. For purposes of this disclosure, the flexible part 114 of the housing 105 may also be referred to as a flexing point of the housing 105 operationally configured to bias a clip member 120 to an open position

The hair shaver 100 as shown in FIGS. 9-11 may be described as an aggressive shave hair shaver according to the length of the cutting edge 210 exposed out through the opening 118, i.e., the location of the cutting edge 210 of the blade member 200 in relation a bottom edge 123 of the front portion 107 of the housing 105. As shown in FIG. 1, the length of the exposed slot 113 in each of the opposing blade stops 115, 116 determines the length of the cutting edge 210 exposed out through the opening 118 and, thus, the aggressiveness of the shave performed on an individual.

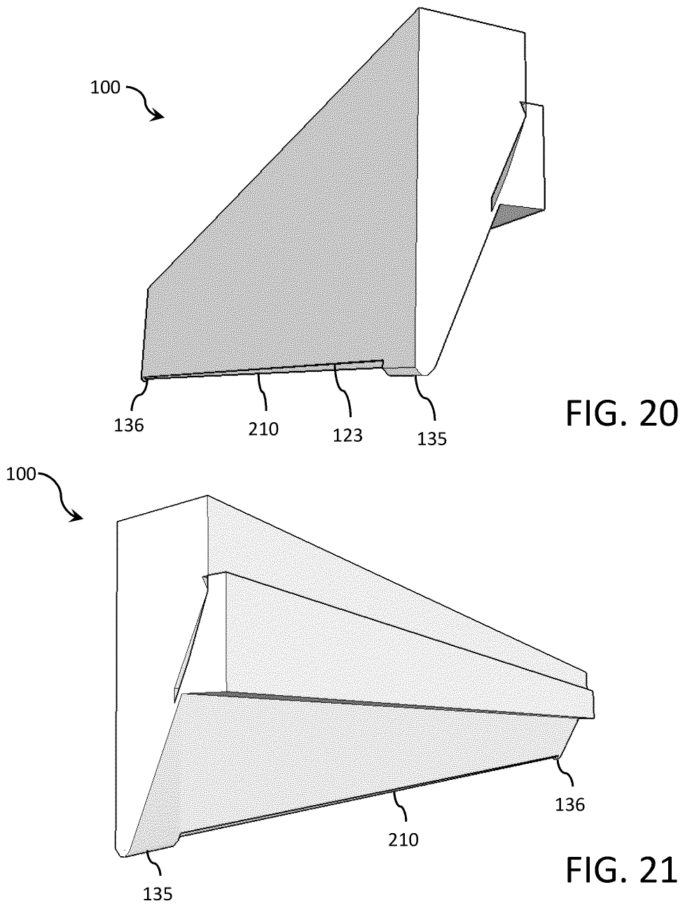

In another embodiment, the housing 105 may be operationally configured to minimize the length of the cutting edge 210 exposed out through the opening in relation to the bottom edge 123 of the front portion 107 of the housing 105 to provide a more mild shave hair shaver 100 compared to an aggressive hair shaver 100 as described in FIGS. 9-11. For example, in one embodiment the housing 105 may be operationally configured to hold a blade member 200 at a higher point within the slot 113 of the housing 105 whereby less of the cutting edge 210 of the blade member 200 is exposed out through the opening 118, e.g., by raising the catch surface 117 of each blade stop 115, 116. In another embodiment as shown in FIGS. 20-21, the bottom edge 123 of the front portion 107 of the housing 105 may be disposed horizontally closer to the bottommost part 135, 136 of each blade stop 115, 116 compared to the housing 105 in the embodiment of FIGS. 9-11, i.e., the length of the exposed slot 113 in each of the opposing blade stops 115, 116 may be reduced, resulting in a shorter length of the cutting edge 210 of the blade member 200 that is exposed out through the opening 118 for contacting an individual's skin during shaving. In one non-limiting embodiment, a suitable length of the exposed cutting edge 210 for an aggressive shave hair shaver 100 as shown in FIGS. 9-11 ranges from or about 1.0 mm (0.04 inches) to or about 2.0 mm (0.079 inches) and a suitable length of the exposed cutting edge 210 for a mild shave hair shaver 100 as shown in FIGS. 20-21 ranges from or about 0.125 mm (0.005 inches) to or about 0.5 mm (0.02 inches).

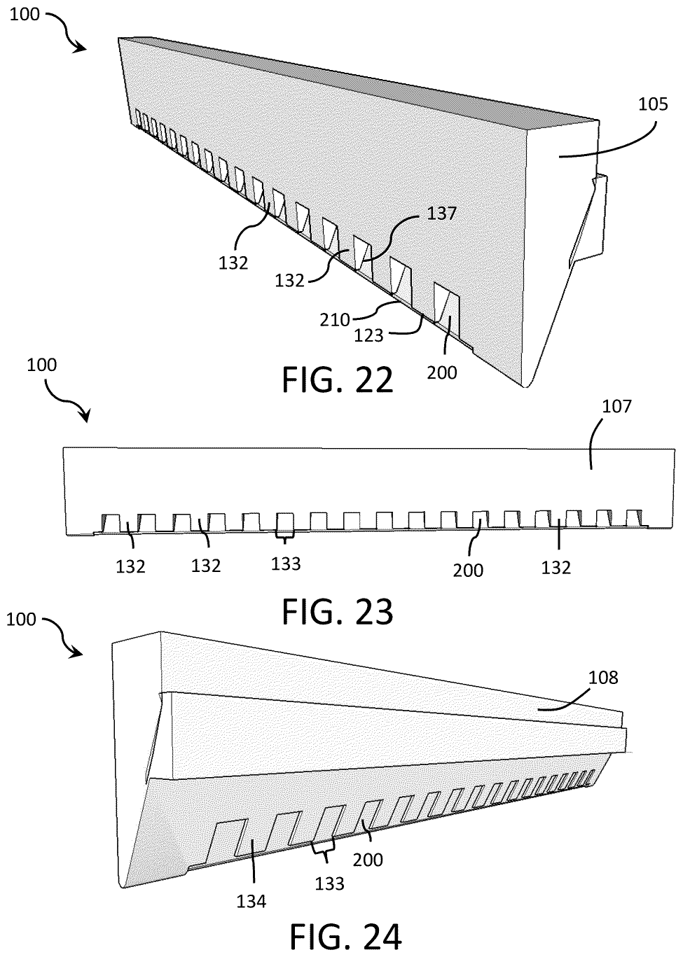

As shown in FIGS. 22-24, in another embodiment the housing 105 of the hair shaver 100 may comprise a combed housing configuration effective to provide a medium shave hair shaver. In one embodiment, the combed housing may include a plurality of front teeth 132 of a common size, e.g., a common length, width and tapering thickness, equally distributed across a lower edge of the front portion 107 of the housing 105 with openings 133 there between of a height and width equal to or about equal to the width of each individual front tooth 132. In another embodiment, the plurality of front teeth 132 and corresponding plurality of openings 133 may be unequally distributed across the lower edge of the front portion 107 of the housing 105. In another embodiment, the plurality of front teeth 132 and the plurality of openings 133 may include one or more different shapes and/or sizes. As shown in FIG. 24, the rear portion 108 of the housing 105 may also include a plurality of rear teeth 134 with distal edges forming part of the bottom portion 112 of the housing 105. The rear teeth 134 may be distributed similar as the front teeth 132 described above. In one particular embodiment, the front teeth 132 and the rear teeth 134 may correspond in number, size and distribution as depicted in FIGS. 22 and 24.

Referring to FIG. 22, each of the front teeth 132 includes a tapered rear surface 137 disposed at an angle the same or similar enough to the angle of the blade member 200 to promote usefulness of the cutting edge 210 of the blade member 200 by locating the cutting edge 210 at or near the bottom edge 123 of each front tooth 132 thereby maximizing the effectiveness or accuracy of shaving operations. In order to provide a medium shave, an embodiment of the hair shaver 100 as shown in FIGS. 22-24 suitably comprises front teeth 132 and rear teeth 134, each having dimensions as described in Example 2 of this disclosure.

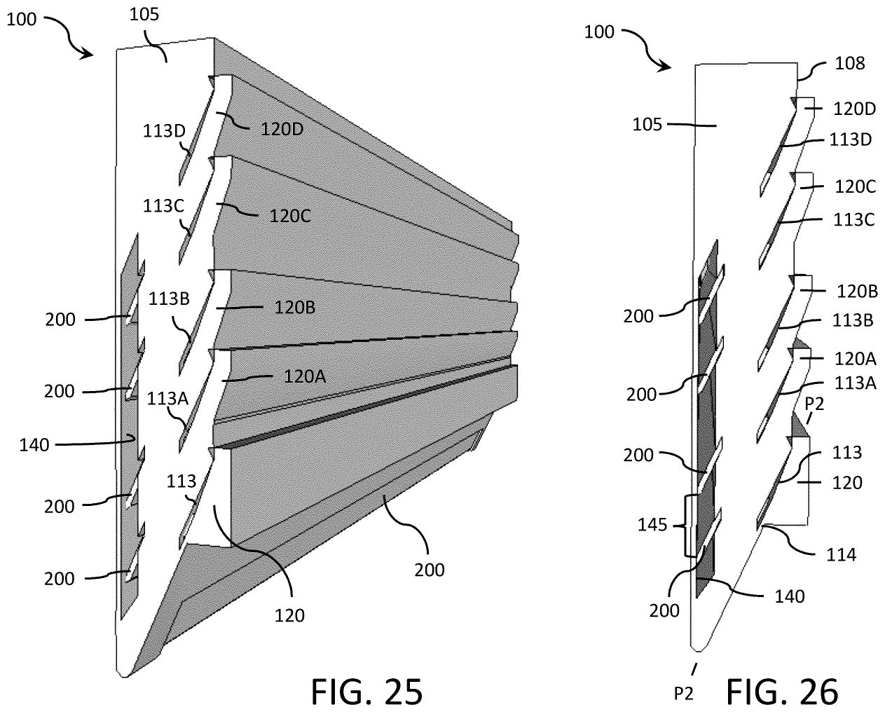

Referring now to FIGS. 25-28, in another embodiment a one-piece housing 105 may be operationally configured to receive and hold a plurality of blade members 200, each blade member 200 being held at a position within the housing 105 effective to provide a desired shave as defined above, i.e., a “multi-blade member 200 hair shaver 100” or “multi-blade hair shaver 100.” Although the housing in this embodiment is operationally configured to house a total of five individual blade members 200, in another embodiment the housing 105 may be configured to hold a different number of blade members 200 (see, for example, FIG. 34). In this embodiment, the rear portion 108 of the housing 105 includes a plurality of moveable clip members (see clip members 120, 120A, 120B, 120C, 120D) operationally configured to be directed to an open position as shown in FIG. 6, each open clip member exposing a corresponding slot (see slots 113, 113A, 113B, 113C, 113D) that is operationally configured to receive a blade member 200 within the housing 105 and allow for removal of the blade member 200 from the housing 105 as described above. In this embodiment, each of the slots 113, 113A, 113B, 113C, 113D may be held in a closed position via a snap-in locking system similar as described above in reference to FIGS. 13-15.

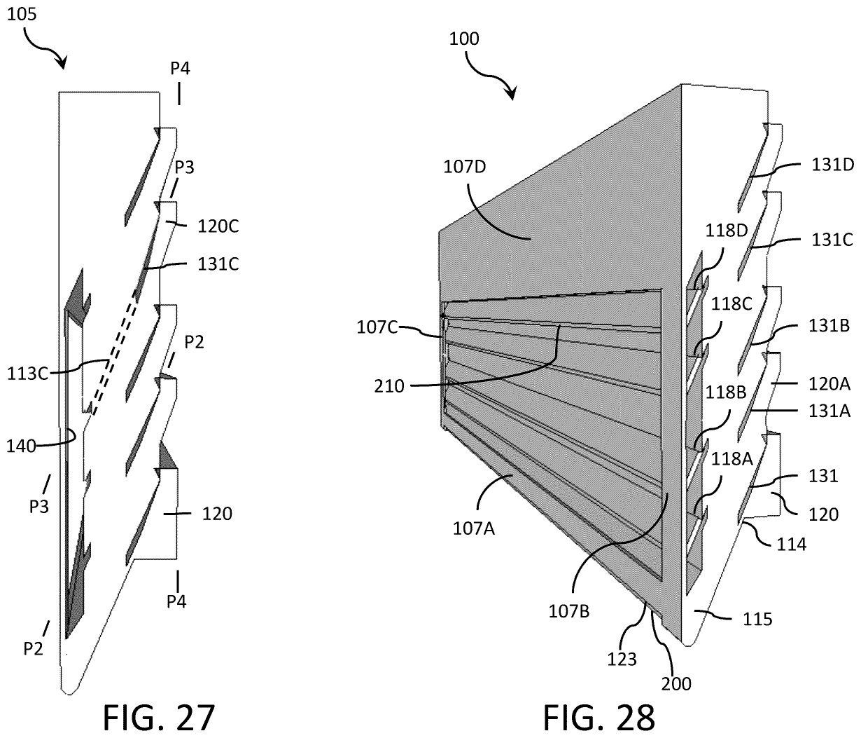

In one embodiment, each of the slots 113, 113A, 113B, 113C, 113D may be oriented to hold corresponding blade members 200 in parallel (see plane P2). In another embodiment, the angle of one or more slots 113, 113A, 113B, 113C, 113D within the housing 105 may differ from the angle of one or more other slots 113, 113A, 113B, 113C, 113D-see slot 113C in FIG. 27 operationally configured to hold a blade member 200 along a different plane (see plane P3) than slots 113A, 113B, 113D.

Similar as described above, the configuration of each of the clip members 120, 120A, 120B, 120C, 120D forms one or more exposed upper portions 131, 131A, 131B, 131C, 131D along the left side portion 110 and right side portion 111 of the housing 105 effective for opening and closing of each of the clip members 120, 120A, 120B, 120C, 120D and for purposes of cleaning of the hair shaver 100. Also, each clip member 120, 120A, 120B, 120C, 120D includes a snap-in locking system similar as described above in reference to FIGS. 13-15. A one-piece housing 105 of this embodiment may be referred to herein as a “multi-mouth housing 105.”

The housing 105 of this embodiment includes a flexible part 114 similar as described above for use with the clip member 120. As shown, clip members 120A, 120B, 120C, 120D do not have a flexible part like similar as flexible part 114. Rather, flexion of clip members 120A, 120B, 120C, 120D is accomplished via the tapering shape of each the corresponding slots 113A, 113B, 113C, 113D and the one or more materials of construction.

With particular reference to FIG. 28, the lowermost clip member 120 may comprise a configuration the same or similar as the clip member 120 described above according to the shape of the housing 105. Although the clip members 120A, 120B, 120C, 120D disposed 30) above clip member 120 may include any functional shape, for purposes of practicality, in one embodiment clip members 120A, 120B, 120C, 120D may each comprise a like shape thinner in configuration than clip member 120 and disposed at an angle whereby the outer surface of the clip members 120, 120A, 120B, 120C, 120D terminate along a plane (see plane P4 in FIG. 27) providing a compact rear portion 108 providing a box-type configuration of the housing 105 from a point at or near the bottom of the clip member 120 to the upper portion 109 of the housing 105.

Still referring to FIG. 28, the front portion 107 of the housing 105 includes an open frame configuration comprising a bottom frame section 107A, a right side frame section 107B, a left side frame section 107C, and an upper frame section 107D operationally configured to expose part of a cutting edge 210 of the blade members 200 housed in each of slots 113A, 113B, 113C, 113D. In this embodiment, the bottom frame section 107A includes a bottom edge 123 and blade stops 115, 116 functionally similar as described above. Also similar as described above, in this embodiment each of the one or more upper portions 131, 131A, 131B, 131C, 131D of the one or more slots 113, 113A, 113B, 113C, 113D are operationally configured to produce an increased resiliency of the corresponding clip member 120, 120A, 120B, 120C, 120D effective to (1) direct a blade member 200 in slot 113 back to an abutment position with the opposing blade stops 115, 116 and (2) direct a blade member 200 in each of slots 113A, 113B, 113C, 113D back to an abutment position between the cutting edge 210 of each blade member 200 and an inner surface 140 of the right side frame section 107B and the left side frame section 107C once the hair shaver 100 is removed from an individual's skin or once less pressure is applied to the cutting edge 210 of the blade member 200. Accordingly, the inner surface 140 of the right side frame section 107B and the left side frame section 107C act as catch surfaces or abutment surfaces for cutting edges 210 of blade members 200 in each of slots 113A, 113B, 113C, 113D. In this embodiment, the inner surface 140 of the right side frame section 107B and the left side frame section 107C are provided as planar surfaces. In another embodiment, the inner surface 140 of the right side frame section 107B and/or the left side frame section 107C may comprise protrusions such as ledge type surfaces and/or grooves operable as catch surfaces for cutting edges 210 for blade members 200 in each of slots 113A, 113B, 113C, 113D. In addition, part of the front portion 107 forming openings 118A, 118B, 118C, 118D is recessed apart from the inner surface 140 of the right side frame section 107B and the left side frame section 107C effective to form fluid channels between adjacent blade members 200 (see fluid channel 145) for purposes of cleaning of the hair shaver 100 as described above. As understood by the skilled artisan, a hair shaver having an increased number of blade members typically reduces the space or span between adjacent blade members, which reduces rinsability of the hair shaver. The open frame configuration of the front portion 107 of this embodiment provides for effective rinsability of the hair shaver 100 regardless the number of blade members 200 employed.

A single blade hair shaver 100 and a multi-blade hair shaver 100 of this disclosure may comprise a skin guard member as known in the art of wet shavers according to one or more desired shaving characteristics. For a more aggressive shave, a multi-blade hair shaver 100 may be provided without a skin guard in order to better shave longer hair or stubble, e.g., hair of at least 3.0 mm (0.118 inches) in length out from the outer surface of the epidermis layer of skin, as the aggressiveness of a lowermost blade member 200 may more easily cut hair of this length and one or more other blade members 200 disposed above the lowermost blade member 200 provide a closer shave having to only cut shorter hair following an initial cutting via the lowermost blade member 200.

For purposes of this disclosure, in terms of multi-blade hair shavers only the aggressiveness of the lowermost blade member 200 housed in slot 113 may be controlled according to the housing 105 configurations described above. The other blade members 200 of a multi-blade hair shaver 100 are operationally configured to provide a milder shave compared to the lowermost blade member 200 according to the abutment position of the cutting edges 210 of the other blade members 200 with the inner surface 140 of the right side frame section 107B and the left side frame section 107C reducing the surface area of the cutting edges 210 of the other blade members 200 that is exposed for contacting an individual's skin during shaving.

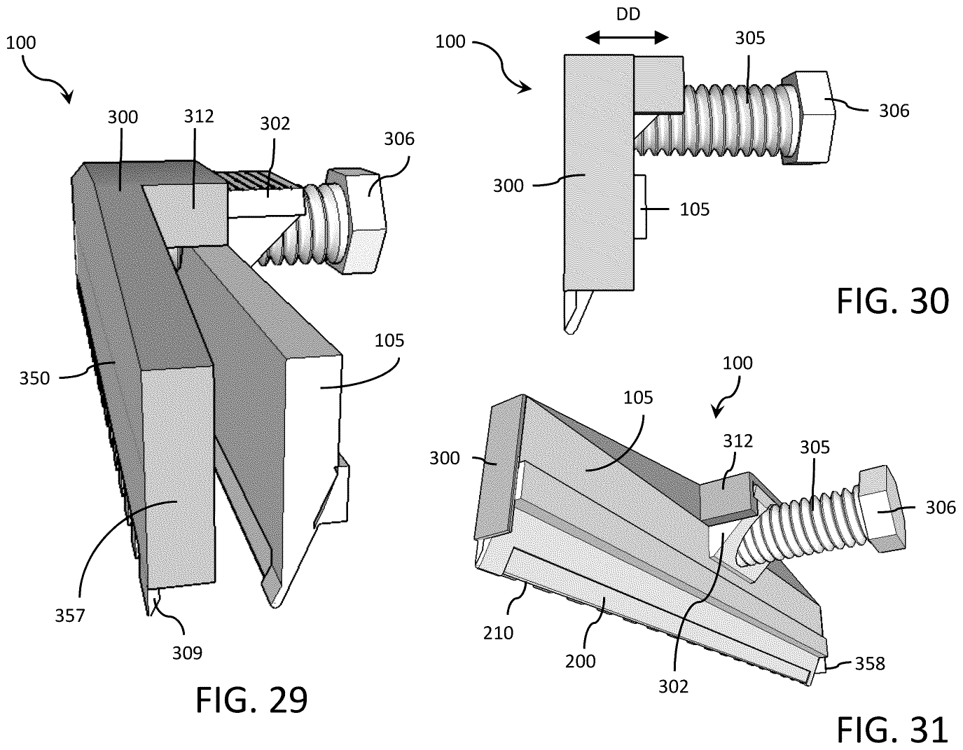

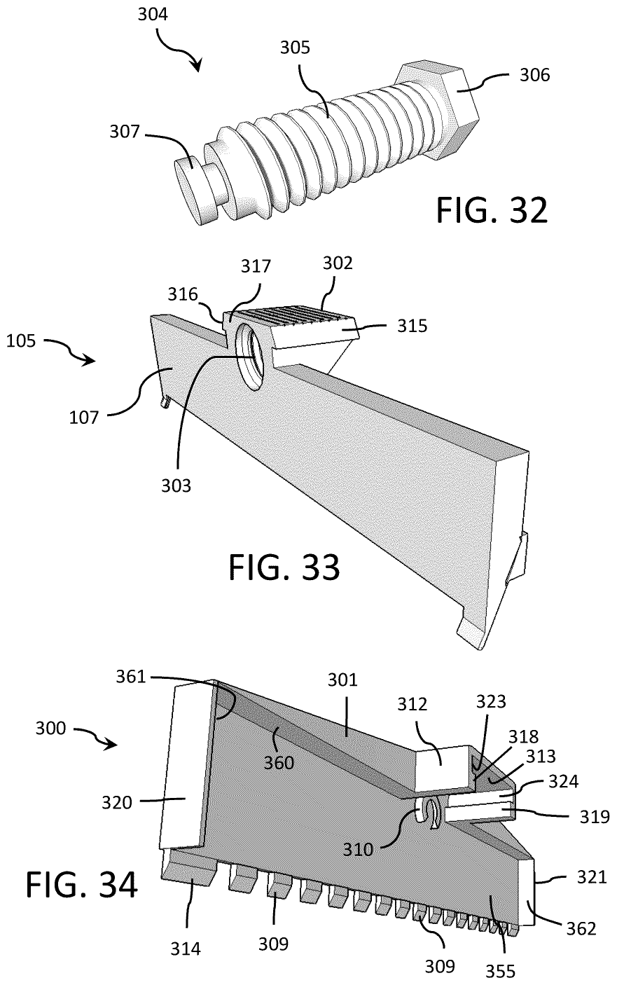

Referring now to FIGS. 29-33, in another embodiment a hair shaver 100 operationally configured to hold a single blade member 200 may be provided as an adjustable hair shaver 100 effective to provide a desired hair shave and/or hair trimming. In one embodiment, an adjustable single blade member 200 hair shaver 100 may include a stationary housing 105 adjustably secured to an adjustable member 300 via one or more actuation members 304. As shown, the adjustable member 300 may be provided as a combed member comprising a front side including a planar front surface 350 with a plurality of teeth 309 disposed along a bottom part of the front surface 350 from a right side 320 of the adjustable member 300 to a left side 321 of the adjustable member 300 similar as described above. In this embodiment, the front surface 350 is operationally configured as a contact surface against an individual's skin during shaving operations. In another embodiment, the front surface 350 may comprise a non-planar surface similar as described above in reference to the front portion 107 of the housing 105. In another embodiment, the bottom edge of the adjustable member 300 may be a straight edge similar as the bottom edge 123 of the front portion 107 of the housing 105 described above (see, for example, FIG. 9).

In this embodiment, the housing 105 includes an upper body portion 302 comprising one or more threaded apertures 303 of a desired length for receiving the one or more actuation members 304 there through. The one or more actuation members 304 comprise a first end 306 for manually turning the one or more actuation members 304 and a second end 307 comprising a connector for releasably mating with a receiving member 310 on the adjustable member 300, e.g., a slip-on connection, and an elongated cylindrical threaded body 305 for threadedly communicating with the one or more threaded apertures 303. In one embodiment, the elongated cylindrical threaded body 305 includes a threaded surface similar as a traditional threaded screw or threaded bolt type fastener.

The adjustable member 300 of this embodiment includes a rear portion operationally configured to receive the housing 105 in an abutment position as shown in FIGS. 30 and 31. Herein, an abutment position as shown in FIGS. 30 and 31 may be described as a fully retracted position of the adjustable hair shaver 100.

In this embodiment, the rear portion of the adjustable member 300 includes a planar seat 355 configured as an abutment surface for the front portion 107 of the housing 105. The rear portion of the adjustable member 300 further includes a planar inner surface 360 disposed along an upper edge of the seat 355, a planar inner surface 361 disposed along a right side of the seat 355 and a planar inner surface 362 disposed along a left side of the seat 355 forming abutment surfaces for the upper portion 109, the left side portion 110 and the right side portion 111 of the housing 105. As shown, the inner surface 360 is formed by a raised body 301 disposed along an upper part of the adjustable member 300 and inner surfaces 361 and 362 are formed by opposing sidewalls 357, 358 extending out perpendicular from the seat 355 operationally configured to enclose at least part of the left side portion 110 and the right side portion 111 of the housing 105. In this embodiment, outer surfaces of the opposing sidewalls 357, 358 form the right side 320 and the left side 321 of the adjustable member 300.

As shown in FIG. 34, the adjustable member 300 further comprises a frame member 312 extending out from the raised body 301 dividing the inner surface 360 into two equal parts thereby extending part of the seat 355 upward as a location for the receiving member 30) 310 and as an abutment surface for a front surface 317 of the upper body portion 302. In this embodiment, the frame member 312 has an inner surface 313 operationally configured to receive the upper body portion 302 therein in a manner effective to maintain linear alignment of the adjustable member 300 with the housing 105 during adjustment of the hair shaver 100 whereby turning of the one or more actuation members 305 in one direction draws the adjustable member toward the housing 105 and vice versa according to the thread pattern of the one or more actuation members 305 and the one or more threaded apertures 303 (see directional arrow DD in FIG. 30 illustrating direction of linear movement of the adjustable member 300).

For purposes of maintaining linear alignment, the inner surface 313 of the frame member 312 may correspond in size and shape to the upper body portion 302 of the housing 105. For example, as shown in FIG. 33, in one embodiment the upper body portion 302 may comprise opposing lateral members 315, 316 extending out from the upper body portion and the inner surface 313 of the frame member 312 may include opposing guide members 318, 319 forming opposing channels 323, 324 for sliding of the lateral members 315, 326 from a fully retracted position (see FIG. 31) to one or more extended positions (see FIG. 29). Although an adjustable hair shaver 100 may be built to scale, for shaving and trimming of mammalian hair, at a fully extended position of the hair shaver 100, the bottom edges 314 of the teeth 309 of the adjustable member 300 are set apart from the cutting edge 210 of the blade member 200 in the housing 105 at a distance of or about 1.0 mm (0.04 inches). In one embodiment, the length of the threaded body 305 of the actuation member 304 determines the maximum distance between the adjustable member 300 and the housing 105. As such, in an embodiment for shaving and trimming of mammalian hair, the threaded body 305 has a length of or about 25.0 mm (0.98 inches). Other adjustable hair shaver 100 configurations are herein contemplated. For example, an adjustable member 300 may be adjusted in relation to a housing 105 using the types of adjustments as described in U.S. Pat. No. 10,987,820 B2, titled “Adjustable Body Shaver, System and Method,” issued on Apr. 27, 2021, the content of which is herein incorporated by reference in its entirety.

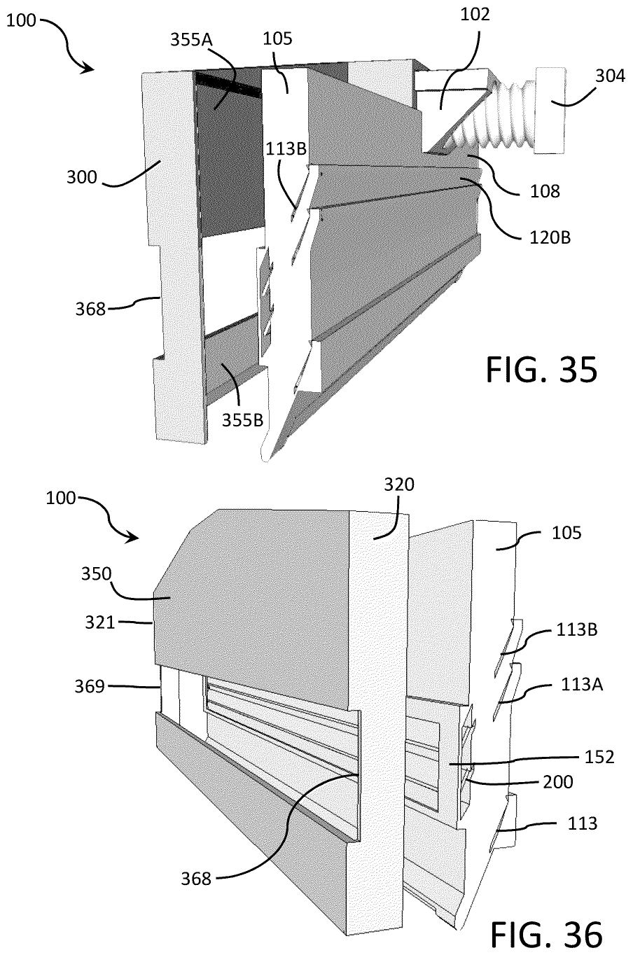

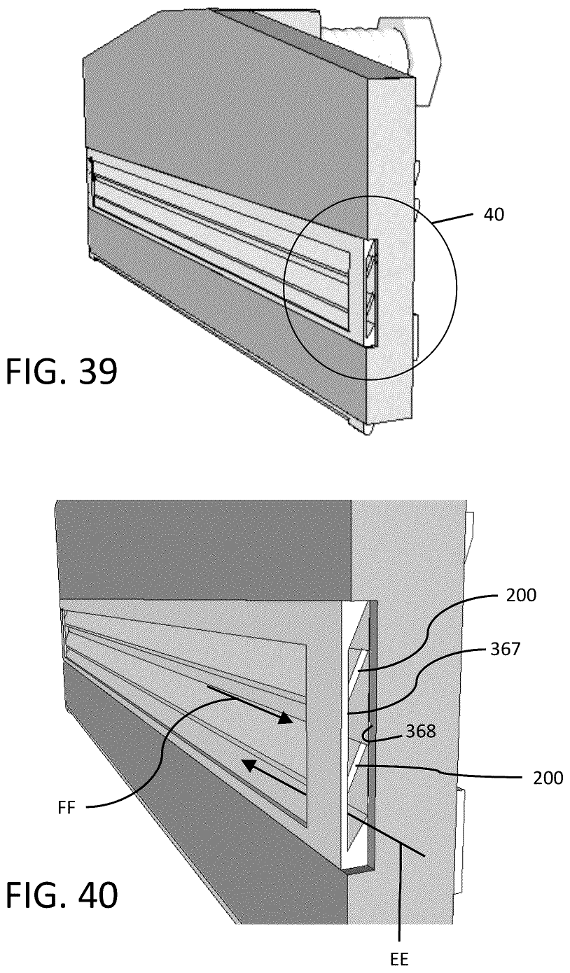

FIGS. 35-40 depict another embodiment of an adjustable hair shaver 100 operationally configured to hold a plurality of blade members 200. The adjustable hair shaver 100 of this embodiment is suitable for hair shaving and/or hair trimming operations. Similar as above, the adjustable member 300 of this embodiment includes a rear portion for receiving the housing 105 in an abutment position providing a fully retracted position of the adjustable hair shaver 100 as shown in FIG. 39. In this embodiment, the adjustable member 30) 300 includes a front portion 107 including a two-part front surface 350 and a rear portion 108 including a corresponding two-part seat 355. Here, the two-part front surface 350 includes an upper front surface 350A and a lower front surface 350B separated by an opening 351 and the opposite sides of the upper front surface 350A and lower front surface 350B comprise an upper seat 355A and lower seat 355B.

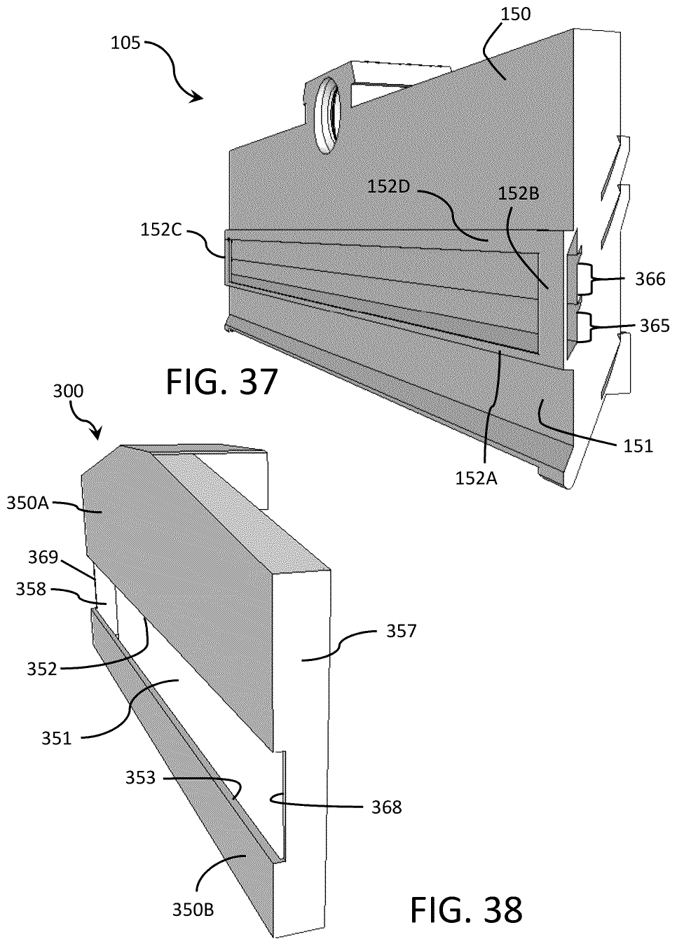

The front portion 107 of the housing 105 includes an upper planar surface 150 operationally configured to abut the upper seat 355A, a lower planar surface 151 operationally configured to abut the lower seat 355B, and an open frame member 152 disposed there between that is projected forward from surfaces 150 and 151 in a manner effective to mate with the opening 351 as shown in FIGS. 39 and 40. As shown in FIG. 37, the open frame member 152 comprises a bottom frame section 152A, a right side frame section 152B, a left side frame section 152C, and an upper frame section 152D and the upper front surface 350A of the adjustable member 300 comprises a lower edge 352 and the lower front surface 350B comprises an upper edge 353, edges 352, 353 comprising abutment surfaces for a bottom side of the bottom frame section 152A and an upper side of the upper frame section 152D. Still referring to FIG. 37, the projected configuration of the open frame member 152 is effective to form fluid channels between adjacent blade members 200 (see fluid channels 365 and 366) for purposes of cleaning of the hair shaver 100 as described above. In this embodiment, inner surfaces of the right side frame section 152B and the left side frame section 152C act as catch surfaces for blade members 200 similar as inner surface 140 described above (see inner surface 367 of the right side frame section 152B in FIG. 40).

Similar as described above, the adjustable member 300 of this embodiment includes opposing sidewalls 357, 358 that extend out perpendicular from the upper seat 355A and the lower seat 355B operationally configured to enclose at least part of the left side portion 110 and the right side portion 111 of the housing 105. Likewise, outer surfaces of the opposing sidewalls form the right side 320 and the left side 321 of the adjustable member 300. In this embodiment, the opposing sidewalls 357, 358 include cutout portions 368, 369 operationally configured to provide access to the fluid channels 365 and 366 of the open frame member 152 when the adjustable hair shaver 100 is set to a fully retracted position (see directional arrows EE and FF representing directional fluid flow through for purposes of cleaning of the hair shaver 100 in FIG. 40). As understood by the skilled artisan, fluid may flow in one or more other directions, e.g., front to either side, upward, downward.

In the embodiment of FIGS. 35-40 the housing 105 is depicted comprising a total of three slots 113, 113A, 113B. And, although the total number of slots of the housing 105 may vary, the proximity of an uppermost slot and uppermost clip member to the upper portion 109 of the housing 105, e.g., see location of slot 113B and clip member 120B, is limited by the location of the upper body portion 302 along the rear portion 108 of the housing 105.

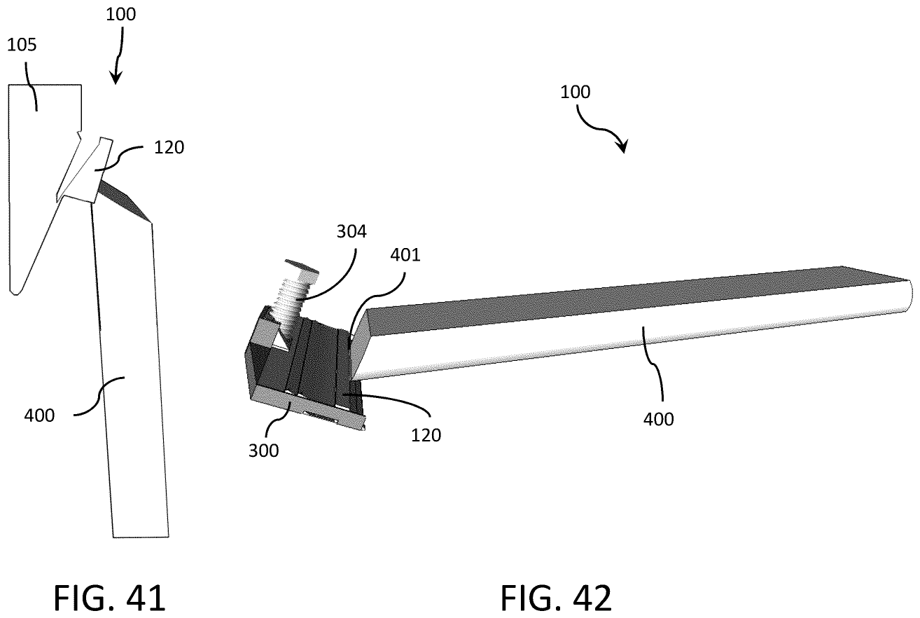

With reference to FIGS. 41 and 42, a hair shaver 100 may further comprise a handle 400 permanently connected or releasably connected to the housing 105. In these embodiments, the handle 400 is shown permanently connected to the clip member 120 at a point effective for an individual to direct the clip member 120 between an open and closed position via manual operation of the handle 400. In one embodiment, the housing 105 and handle 400 may be manufactured as a one-piece member. In another embodiment, the housing and handle 400 may be manufactured as separate members permanently attached to produce a hair shaver 100 as shown in FIGS. 36 and 37. In one embodiment, the handle 400 may be permanently attached to the housing 105 in a fixed position. In another embodiment, the handle 400 may be pivotally connected to the housing 105 via a hinge or the like. Referring to FIG. 42, in one embodiment the handle 400 and housing 105 may be provided as a one-piece construction whereby the junction 401 between the proximal end of the handle 400 and the housing 105 comprises a sized material constructed from one or more materials effective as an integral hinge or living hinge of the hair shaver 100. In this embodiment, the proximal end of the handle 400 includes a tapered surface forming an apex at the junction 401. Suitably, the size and the materials of construction of the junction 401 provide a biasing force effective to maintain the housing 105 in a fixed position until a shaving force is applied to the housing 105.

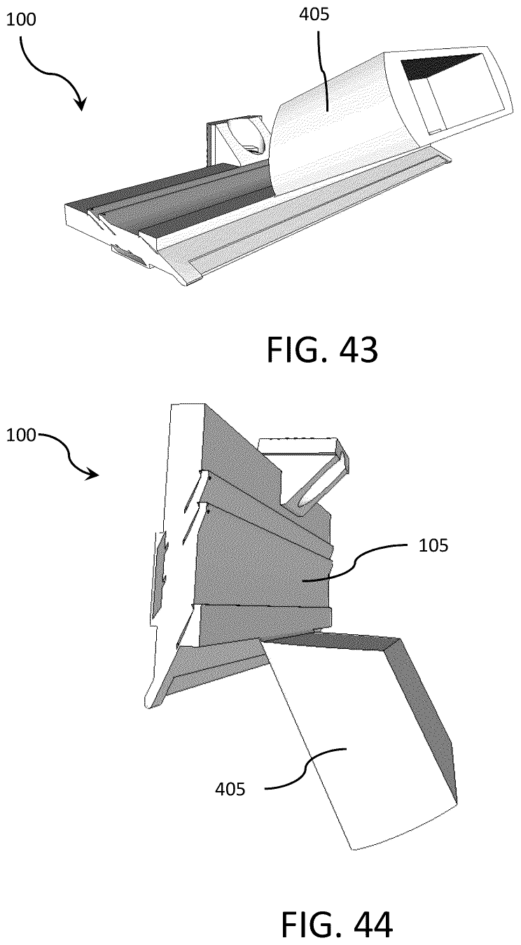

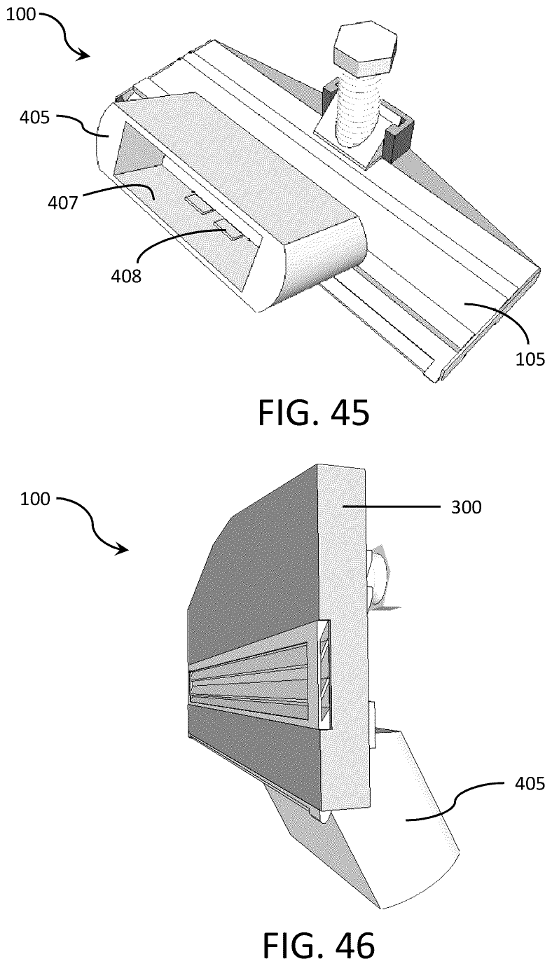

With reference to FIGS. 43-46, a hair shaver 100 may further comprise a handle coupler 405 (hereafter “coupler 405”) releasably or permanently secured to the housing 105. As shown in FIG. 45, a coupler 405 may include a female mating surface 407 for receiving a proximal end of a handle 400 therein for operation of the hair shaver 100. In this embodiment, the female mating surface 407 comprises one or more connectors 408 operationally configured to engage corresponding connectors on the handle 400 in a snap-in connection. Ultimately, the type of connection between the housing 105 and handle 400 may vary as various modes of releasable handle 400 attachment are known in the art of wet shavers. In addition to U.S. Pat. No. 10,987,820 B2 discussed above and incorporated by reference in its entirety, other non-limiting examples of suitable housing 105 and handle 400 attachments are described in U.S. Pat. No. 8,793,880 B2, titled “Shaving Razor Adapter Attaching a Shaving Razor Cartridge to a Shaving Razor Handle,” issued on Aug. 5, 2014; and U.S. Pat. No. 7,168,173 B2, titled “Shaving System,” issued on Jan. 30, 2007, the content of each of which is herein incorporated by reference in its entirety.

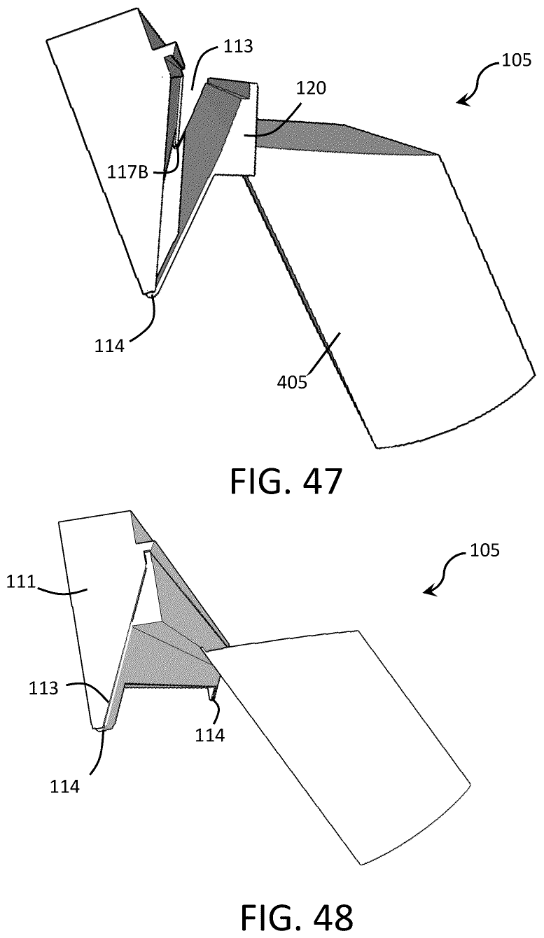

With reference to FIGS. 47-48, in another embodiment the slot 113 of a one-piece housing 115 may be exposed along the left side portion 110 and right side portion 111 of the housing 105 providing a larger mouth type configuration for exposing the slot 113 for inserting and removing of a blade member 200 into and out from the slot 113. In such an embodiment, the slot 113 may be referred to as an exposed slot 113. An exposed slot 113 provides for ease of blade member 200 handling as the blade member 200 does not have to be slid in and out of the slot 113, but rather may be directly set at a desired location within the slot 113 and lifted directly out from the slot 113 during removal.

In this embodiment, in addition to operating as catch surfaces 117, the lowermost part of opposing ends of the slot 113 are also operationally configured as flexible parts 114 operationally configured to flex or bend in a manner effective for the clip member 120 to be directed to between an open position as shown in FIG. 47 and a closed position as shown in FIG. 48. In this embodiment, the flexible parts 114 are operationally configured to bias the clip member 120 apart from the inner surface 122 of the housing 105. The housing 105 may be directed to a closed position or locked position via a snap-in locking system similar as described above.

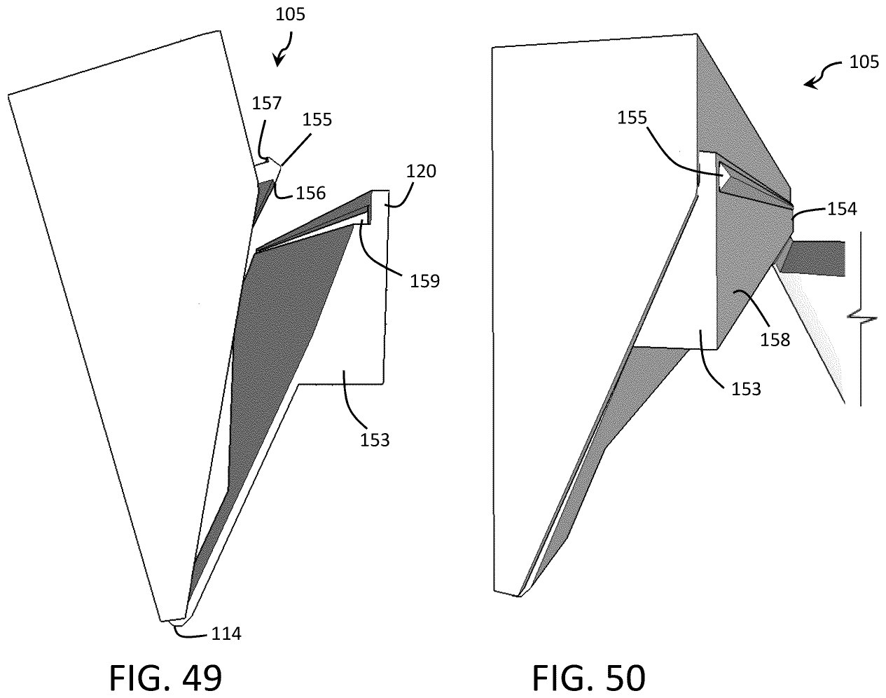

Other snap-in locking systems may also be employed as shown in the embodiments of FIGS. 49-51. For example, in the embodiment of FIGS. 49-50 the snap-in locking system comprises an elongated male member 155 extending out from the uppermost part 142 of the rear portion 108 of the housing 105 operationally configured to mate with an elongated aperture 159 disposed along the clip member 120 in a locked position. In this embodiment, the male member 155 includes opposing shoulders 156, 157 spanning a length greater than the width of the aperture 159 whereby the shoulders 156, 157 effective to engage a rear surface 158 of the clip member 120 to lock the housing 105 in a closed position. For ease of use, the male member 155 and/or the clip member 120 may be constructed from one or more flexible materials allowing the shoulders 156, 157 and/or the part of the clip member 120 defining the aperture 159 to flex and/or bend allowing the male member 155 to freely move through the aperture 159 between an open unlocked position (FIG. 49) and a closed locked position with the aperture 159 (FIG. 50). As shown, in one embodiment the male member 155 and the aperture 159 may extend from a right side 153 of the clip member 120 to a left side 154 of the clip member 120 and comprise the same or a substantially similar length. In another embodiment, the aperture 159 may include a length greater than the male member 30) 155. In another embodiment, the housing 105 may comprise a plurality of male members 155 for mating with the aperture 159. In another embodiment, the housing 105 may comprise a plurality of male members 155 and a plurality of corresponding apertures 159.

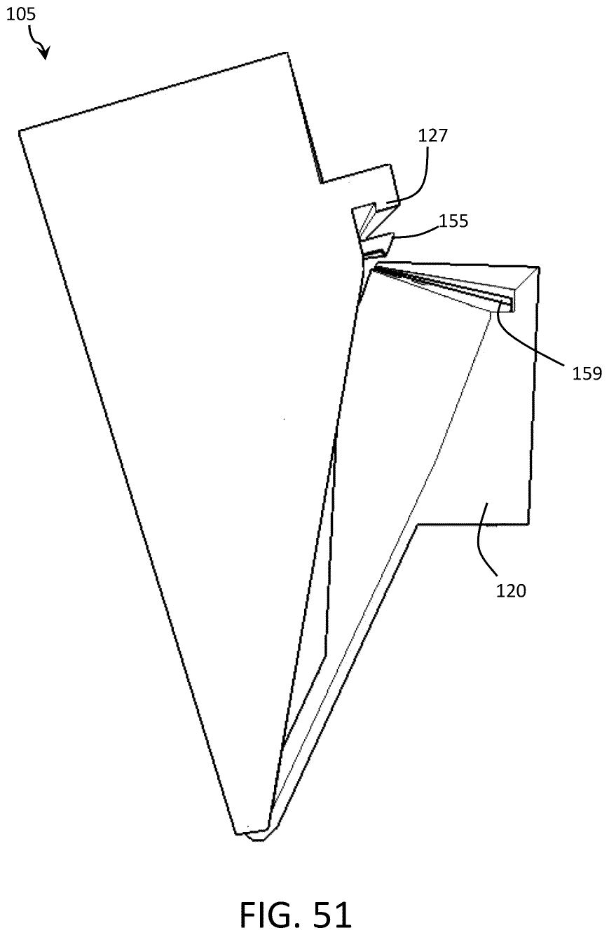

In another embodiment, the housing 105 may comprise a snap-in locking system comprising a combination of the snap-in locking system of the embodiment of FIGS. 47, 48 and the snap-in locking system of the embodiment of FIGS. 49, 50 (see FIG. 51). Although any of the above described snap-in locking systems may be employed, one or more particular snap-in locking systems may be functionally advantageous for use with a particular housing 105 configuration.

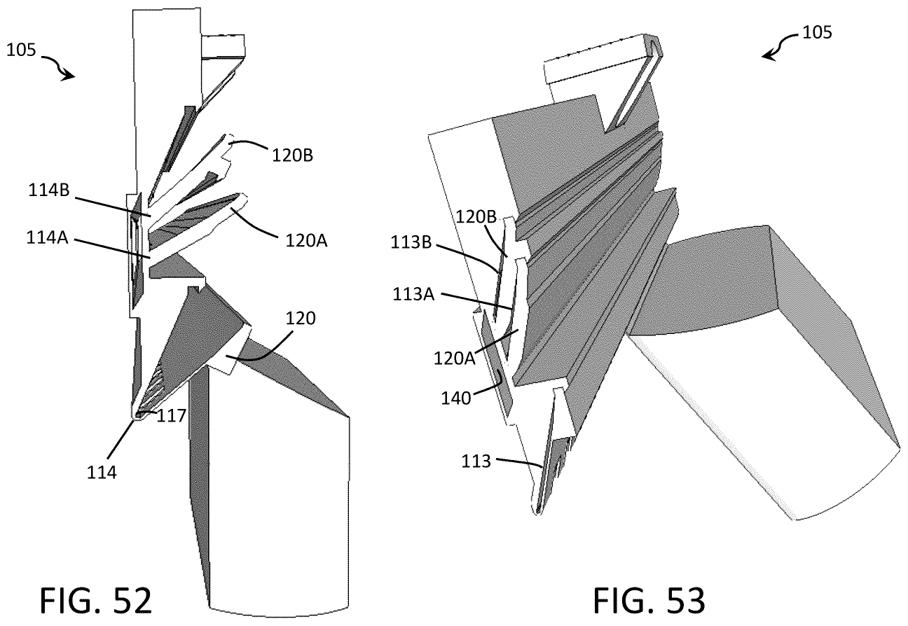

As shown in FIGS. 52 and 53, a one-piece housing 105 of this disclosure may also comprise a plurality of exposed slots operationally configured to receive and hold a plurality of blade members 200—see exposed slots 113, 113A, 113B. Similar as described above, the clip member 120 of this embodiment includes opposing catch surfaces 117 operationally configured as flexible parts 114 for flexing or bending in a manner effective for the clip member 120 to be directed to between an open position as shown in FIG. 52 and a closed position as shown in FIG. 53. Similarly, clip members 120A and 120B include flexible parts 114A and 114B operationally configured to flex or bend in a manner effective for the clip members 120A and 120B to be directed between an open position as shown in FIG. 52 and a closed position as shown in FIG. 53. In this embodiment, the blade members 200 are disposed through slots 113A and 113B whereby the cutting edges 210 of blade members 200 abut the inner surface 140 similar as described above.

Also, in this embodiment the opposing catch surfaces 117 may be configured to bias the clip member 120 apart from the inner surface 122 of the housing 105 to rest each clip member 120, 120A, 120B at an open position as shown in FIG. 52. As shown, each of the clip members 120, 120A, 120B may be directed to an open position of an angular distance effective for passage, i.e., insertion and removal, of blade members 200 without hindrance from the clip members 120, 120A, 120B.

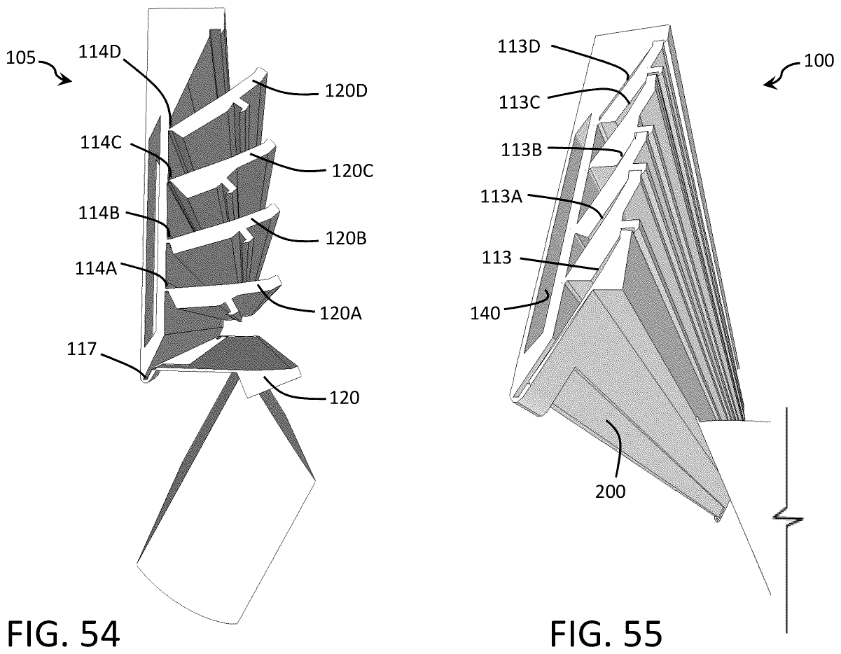

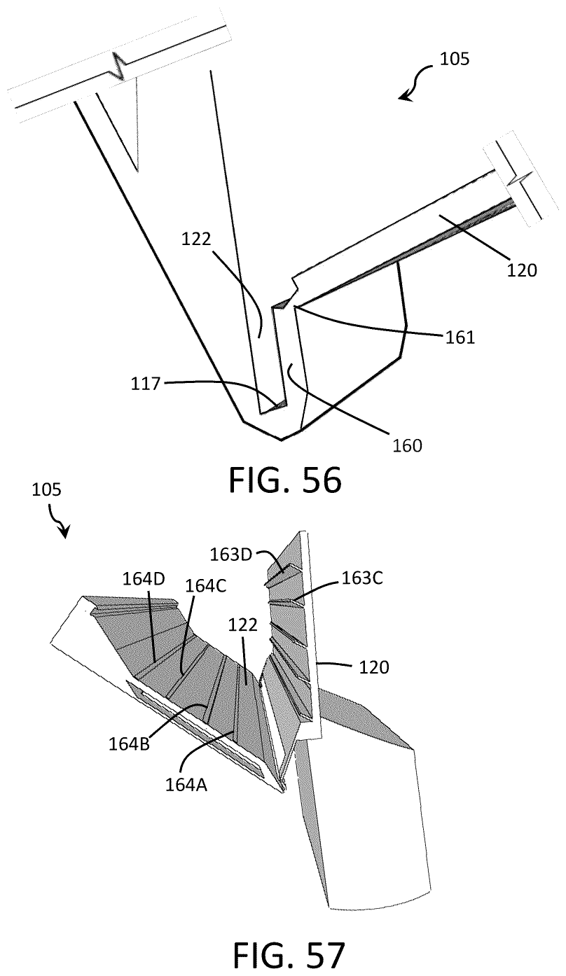

Referring to FIGS. 54 and 55, another embodiment of a one-piece housing 105 having a plurality of exposed slots is shown comprising clip members 120A, 120B, 120C, 120D moveable via flexible parts 114A, 114B, 114C, 114D operationally configured as living hinges or other hinge configurations similar as described above. In this embodiment, the lowermost catch surface 117 is a static member formed at the junction between the inner surface 122 of the housing 105 and a wall member 160 that form a lower portion of the slot 113. As shown in FIG. 56, the clip member 120 is secured to the fixed wall member 160 via a hinge such as a living hinge 161 other hinge configuration. A slot 113 configuration of this embodiment may be particularly advantageous for holding a blade member 200 for hair trimming operations.

With particular reference to FIG. 54, each of the clip members 120, 120A, 120B, 120C, 120D may be directed to an open position an angular distance effective to provide clearance for a higher adjacent clip member. Suitably, the angular distance of travel of individual clip members may depend on the total number of clip members and/or the shape of one or more clip members and/or the spacing between adjacent clip members and/or the one or more materials of construction of the flexible parts 114A, 114B, 114C, 114D and/or the configuration of the housing 105. Living hinge configurations of the flexible parts 114A, 114B, 114C, 114D are effective to provide an operable open position for each of the clip members 120A, 120B, 120C, 120D.

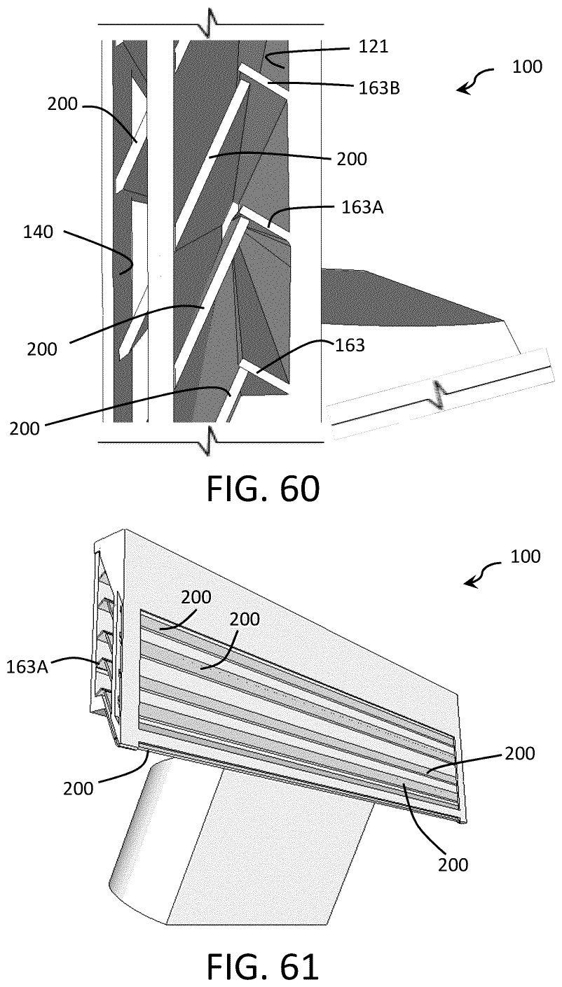

Another embodiment of the housing 105 of a multi-blade hair shaver 100 is provided in FIGS. 57-61 including a single clip member 120 operationally configured to hold a plurality of blade members 200 for shaving operations. In this embodiment, clip member 120 resiliency is accomplished via a plurality of planar resilient members 163-163D (or “planar springs 163-163D”) that extend out from the inner surface 121 of the clip member 120 at an angle effective to engage a blade end 201 of a corresponding blade member 200, e.g., extend out along a plane perpendicular to or substantially perpendicular to the plane of the blade members 200. During shaving operations, each of the planar springs 163-163D is operationally configured to bend or flex upward toward the inner surface 121 of the clip member 120 when pressure is applied to a corresponding blade member 200. Once pressure is removed from the blade members 200, the planar springs 163-163D are operationally configured to return to their original position thereby directing the blade members 200 to a desired location.

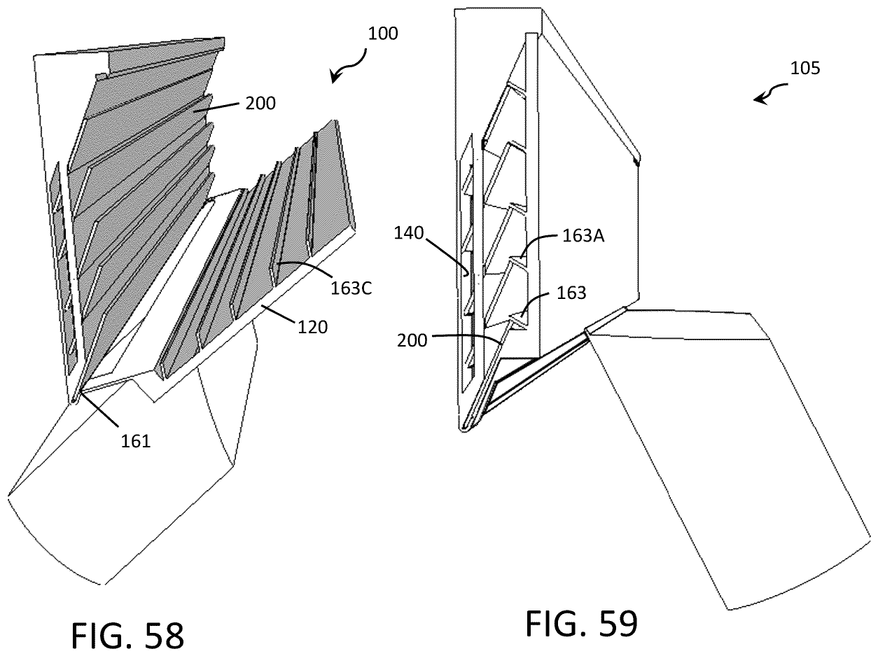

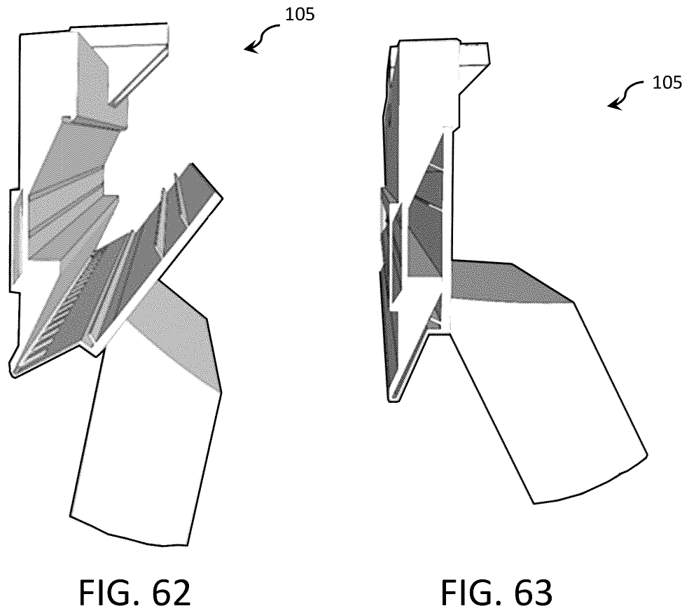

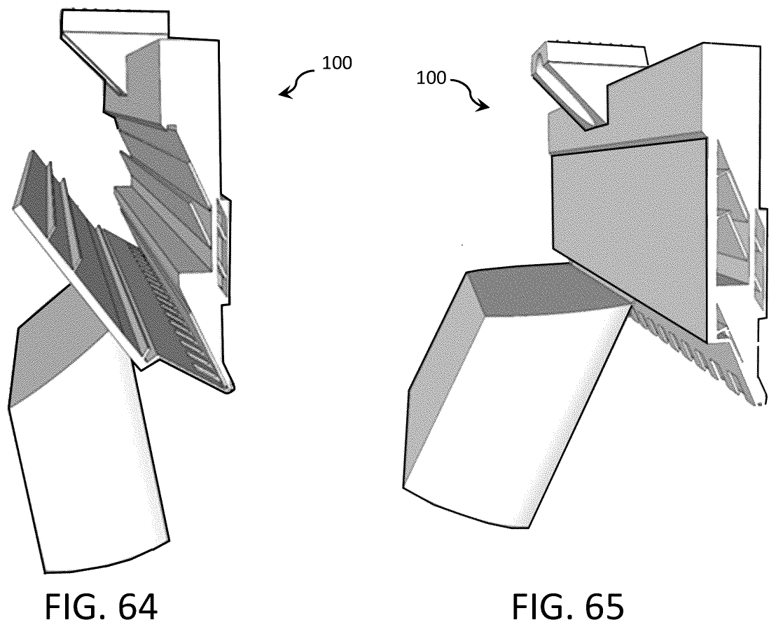

In this embodiment, the one-piece housing 105 comprises a catch surface 117 and a wall member 160 that form a lower portion of the slot 113 similar as shown in FIG. 56. The living hinge 161 allows the clip member 120 to be directed between a biased open position as shown in FIG. 57 and a closed position as shown in FIG. 59. Also, in this embodiment the inner surface 122 of the housing 105 comprises a plurality of linear apertures 164A-164D operationally configured to receive a blade member 200 there through (see FIGS. 57 and 58). A cutting edge 210 of the blade members 200 mated with apertures 164A-164D are operationally configured to abut inner surface 140 as described above. Another embodiment operationally configured for both shaving and trimming operations is provided in FIGS. 62-65.

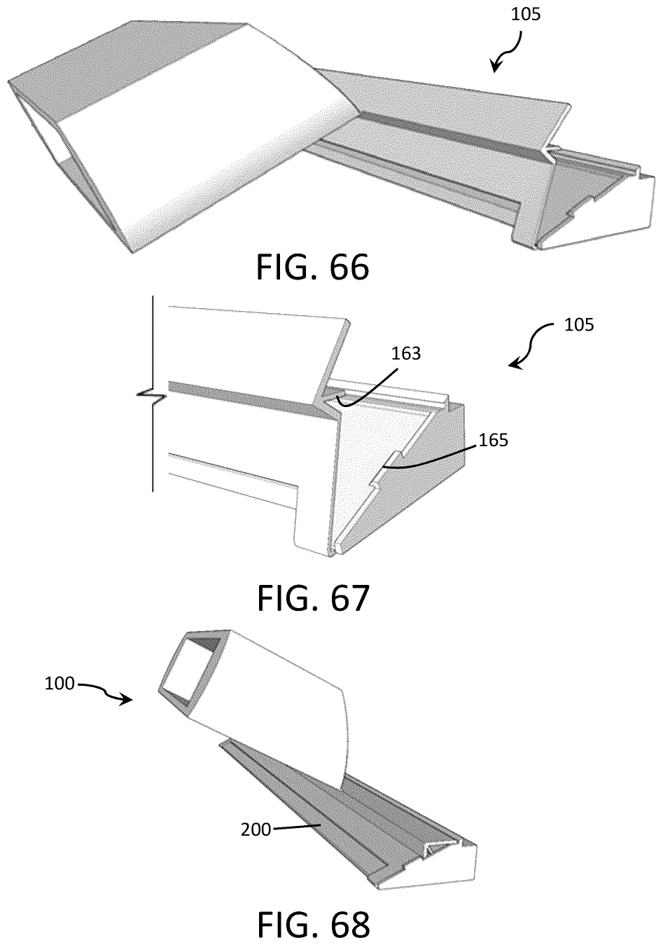

Referring to FIGS. 66-68, in another embodiment a one-piece housing 105 operationally configured to receive and hold a single blade member 200 may include a planar spring 163 similar as described above. In this embodiment, the housing 105 may also comprise one or more side catch members (see catch member 165 in FIG. 67) one either side 110, 111 of the housing 105 operationally configured to receive the clip member 120 in a snap-in position to assist in maintaining the housing 105 in a closed position. In addition, the one or more side catch members are operationally configured to prevent a blade member 200 from escaping laterally out from either side 110, 111 of the housing 105. One or more side catch members may also be employed on a housing 105 of a multi-blade hair shaver 100.

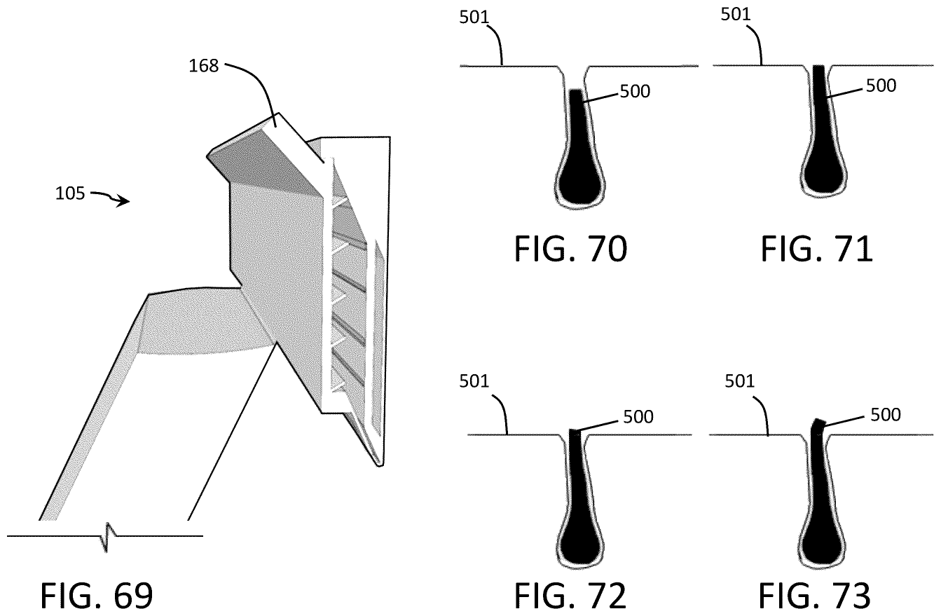

As depicted in FIG. 69, in another embodiment a clip member 120 of the housing 105 may include one or more protruding members, for example, a lever 168 operationally configured for manual manipulation of the clip member 120 between an open and closed position. In another embodiment, the one or more protruding members may include one or more hooks or other catch members. In another embodiment, a clip member 120 may include one or more recessed surfaces or other catch surfaces for manual manipulation of the clip member 120. In another embodiment, a clip member 120 may include one or more textured surfaces for manual manipulation of the clip member 120. Other protruding member configurations and surface configurations are herein contemplated. In one embodiment, a protruding member such as a lever 168 or the like at the distal end of the clip member 120 may be employed in an embodiment of a multi-blade hair shaver 100 including a handle 400 manufactured as a one-piece item. As such, the only disposable part of the hair shaver 100 includes the one or more blade members 200 used as part of the hair shaver 100.

In one embodiment, a blade member 200 of this disclosure may be provided as a four-sided planar member with a cutting edge 210 known in the art of wet shaving razor blades. The configuration of the housing 105 and slot 113 of this disclosure allows for a blade member 200 to simply be inserted into a slot 113 for use without having to modify the blade member 200 and/or add any additional couplers or support members to set the blade member 200 in position for use while shaving.

As understood by the skilled artisan, a hair shaver 100, an adjustable member 300, one or more actuation members 304 and a handle 400 as discussed herein may be constructed of one or more materials effective for its intended purpose as described herein. In particular, a hair shaver 100, an adjustable member 300, one or more actuation members 304 and a handle 400 of this disclosure may be constructed of one or more materials including but not necessarily limited to those materials resistant to chipping, cracking, excessive bending and reshaping as a result of ozone, weathering, heat, moisture, other outside mechanical and chemical influences, as well as various impacts and other loads placed on the hair shaver 100, adjustable member 300, one or more actuation members 304 and handle 400. Also, a hair shaver 100, an adjustable member 300, one or more actuation members 304 and handle 400 of this disclosure may comprise any color or combination of colors.

Suitable hair shaver 100, adjustable member 300, actuation member 304 and handle 400 materials may include, but are not necessarily limited to ferrous metals and non-ferrous metals, metal alloys, polymeric materials, rubbers, glass, plexiglass, filled composite materials, woods, minerals, and combinations thereof. Suitable polymeric materials may include, but are not necessarily limited to thermoplastics, synthetic plastics, semi-synthetic organic plastics, and combinations thereof. Exemplary plastics may include, but are not necessarily limited to nylon, vinyl polymers, polyvinyl chloride (“PVC”), polyethylene, polyethylene terephthalate (“PET”), polymethylpentene, polypropylene, polycarbonate, phenylene oxide, and combinations thereof.

In one embodiment, a hair shaver 100 and adjustable member 300 may be constructed of stainless steel, carbon steel, aluminum, and combinations thereof, e.g., a stainless steel hair shaver 100 and an aluminum adjustable member 300. In one embodiment, a handle 400 may be constructed of stainless steel. In one embodiment, a handle 400 may be constructed of carbon steel. In one particular embodiment, a handle 400 may be constructed of aluminum. In one embodiment, a handle 400 may be constructed of one or more materials providing a handle 400 heavier than the corresponding hair shaver 100, an adjustable member 300 and one or more actuation members 304. In one embodiment, a handle 400 may comprise die casted metal and/or have metal inserts to increase the weight of the handle 400.

In one particular embodiment, a hair shaver 100 and/or adjustable member 300 and/or actuation member 304 and/or handle 400 may be constructed of one or more polymeric materials and one or more pro-degradant additives effective to provide a degradable hair shaver 100 and/or adjustable member 300 and/or actuation member 304 and/or handle 400. Suitable pro-degradant materials may include, but are not necessarily limited to one or more transition metal salts. In addition, a hair shaver 100, adjustable member 300, actuation member 304 and handle 400 of this disclosure may be produced via one or more processes including, but not necessarily limited to assembly of various component parts, injection molding, blow molding, thermoforming, rotational molding, compression molding, three-dimensional printing, film and sheet extrusion, and pipe and cable extrusion as each is understood by the skilled artisan.

A handle 400 of this disclosure may also include an enhanced gripping material to assist a user when holding the handle 400 of a hair shaver 100. The enhanced gripping material may be a rubber, gel, plastic or like material. Also, the enhanced gripping material may include a textured surface.

As understood by the skilled artisan, a blade member 200 of this disclosure may be constructed of one or more materials known in the art of razor blades, e.g., carbide steel, stainless steel, and may comprise one or more surface coatings, e.g., tungsten, titanium.

The disclosure will be better understood with reference to the following non-limiting examples, which are illustrative only and not intended to limit the present disclosure to a particular embodiment.

### Example 1

In a first non-limiting example, a hair shaver 100 of this disclosure is operationally configured to cut body hair 500 at more or lengths relative the skin surface 501 including, but not necessarily limited to the lengths as depicted in FIGS. 70-73.

### Example 2

In a second non-limiting example, a hair shaver 100 as depicted in FIGS. 22-24 includes individual front teeth 132 and rear teeth 134 each having dimensions as shown in Table 2.

TABLE 2

Width: 1.0 mm (0.04 inches);
Length: 1.0 mm (0.04 inches).

### Example 3

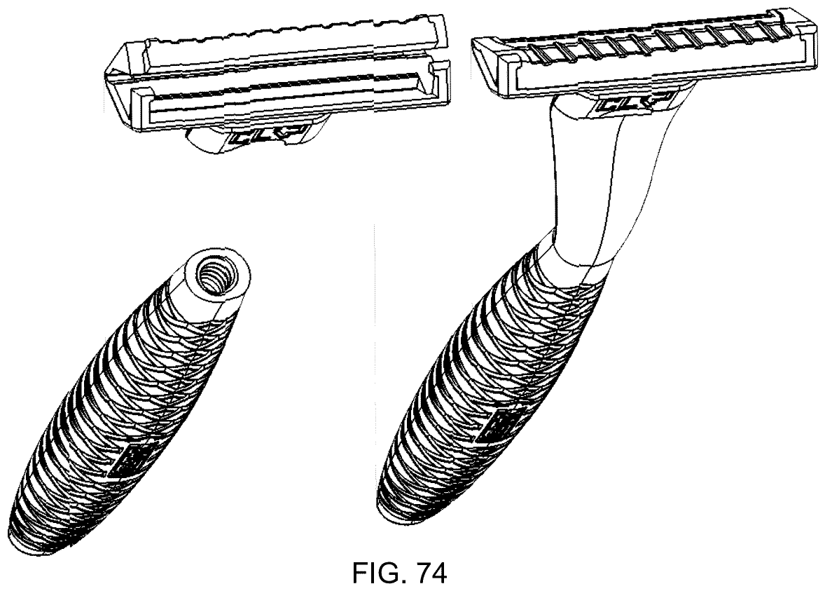

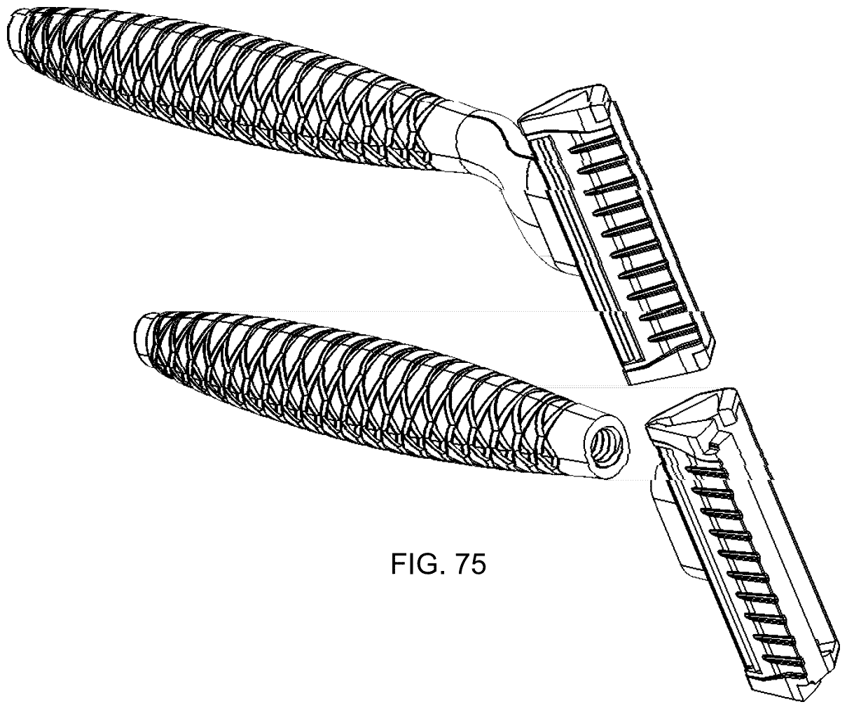

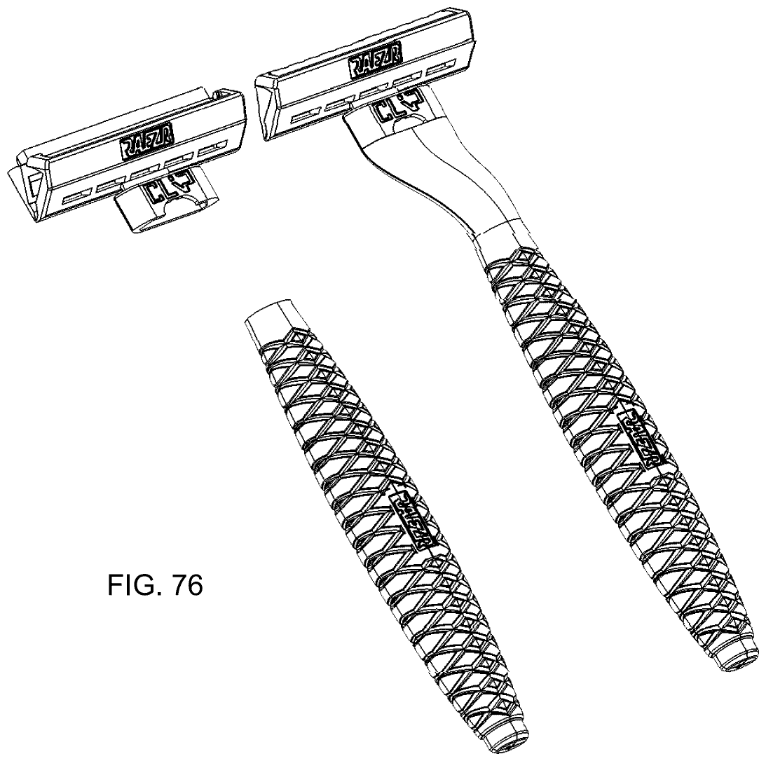

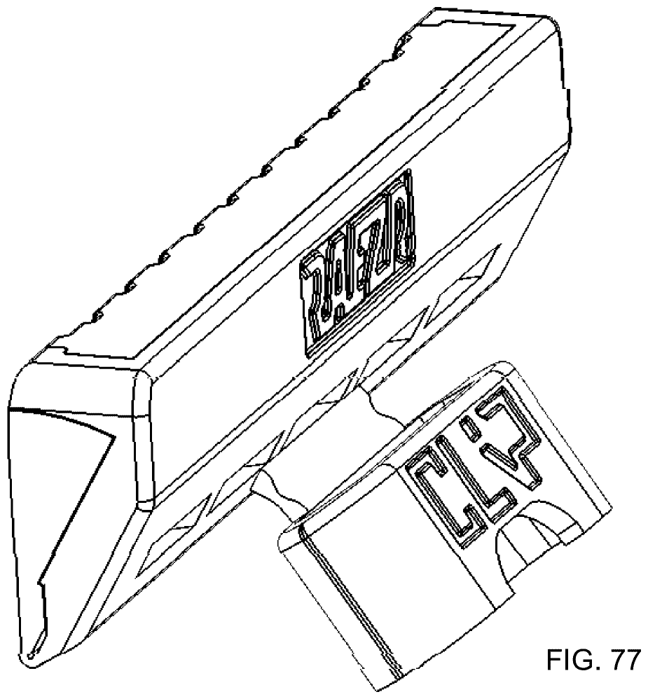

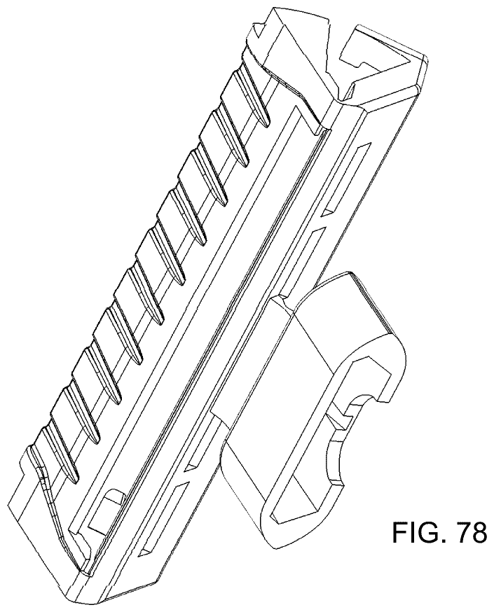

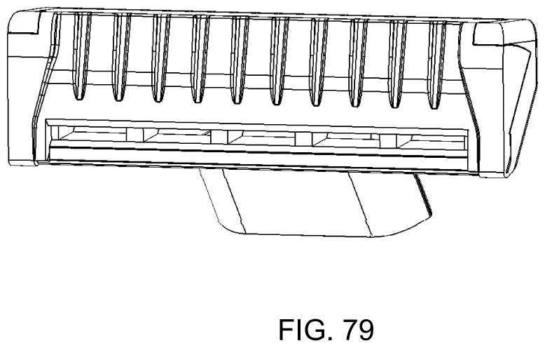

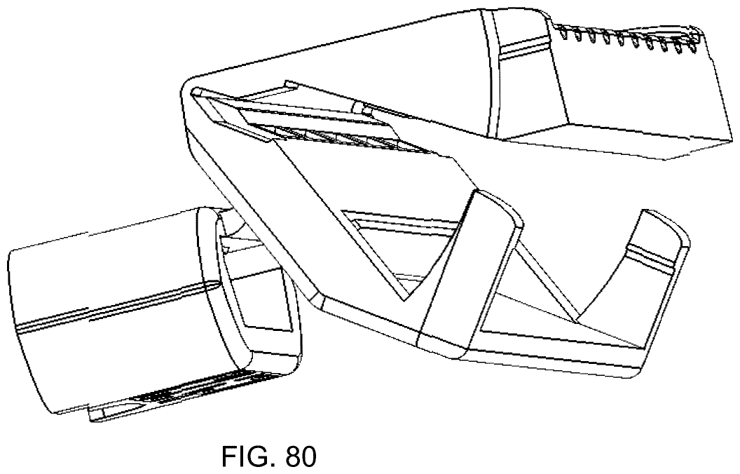

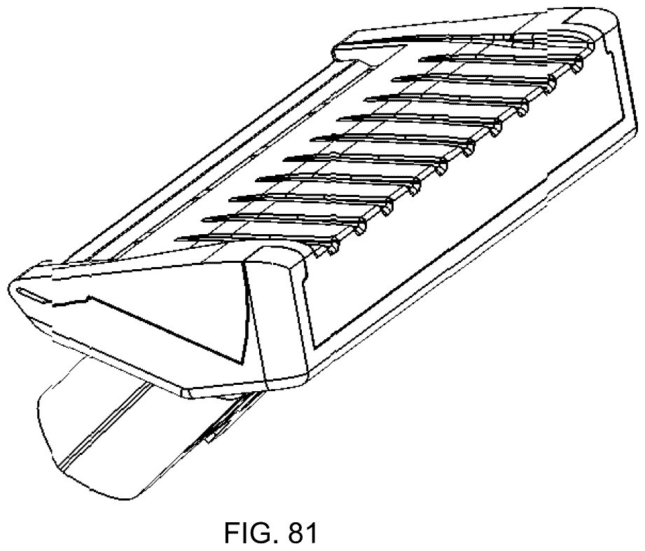

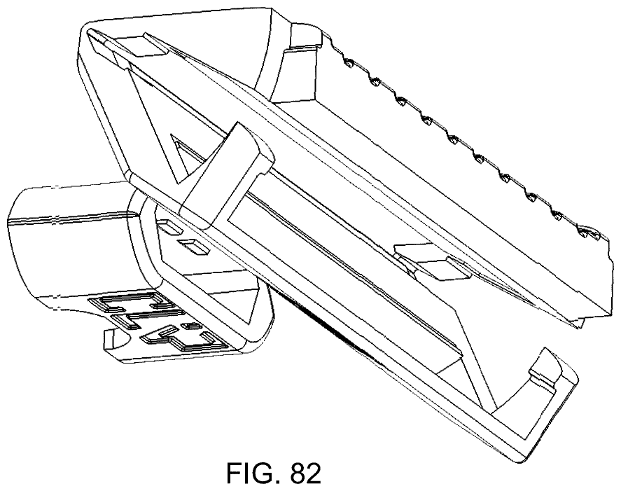

In a third non-limiting example, a hair shaver as depicted in FIGS. 74 through 82 may be described as provided in the following text. Depicted in these figures is a version of a plastic, one-blade non adjustable razor and razor cartridge. As shown, a consumer may choose the type of razor blade they desire, open a mouth of the housing (as shown in the left side of FIG. 74, the bottom of FIG. 75, the left side of FIG. 76, FIGS. 78, 80, and 82) and insert the razor blade into the housing. Closing the housing around the razor (as shown in the right side of FIG. 74, the top of FIG. 75, and right side of FIG. 76, FIGS. 77, 79, and 81) results in a cutting edge of the razor being presented on the shaver's surface. Suitably, the shaver's surface presenting the razor edge can include built in face guards as taught in this disclosure.

### Example 4

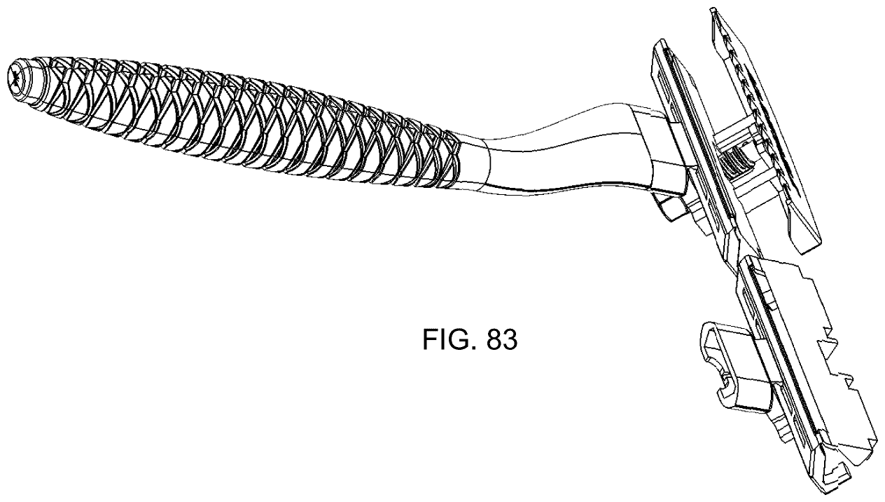

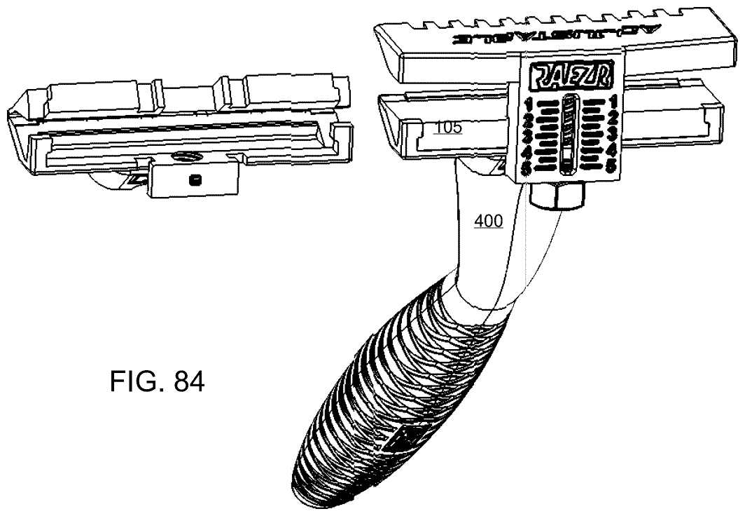

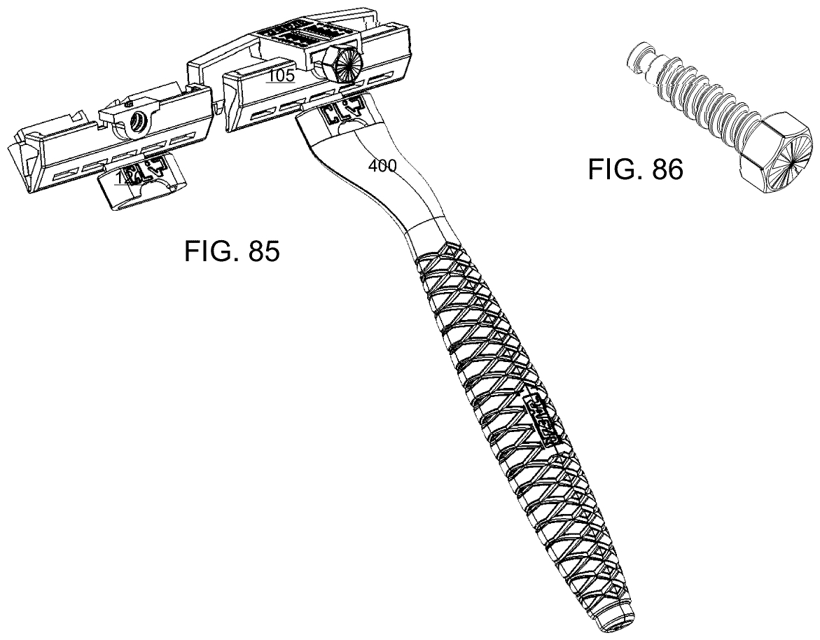

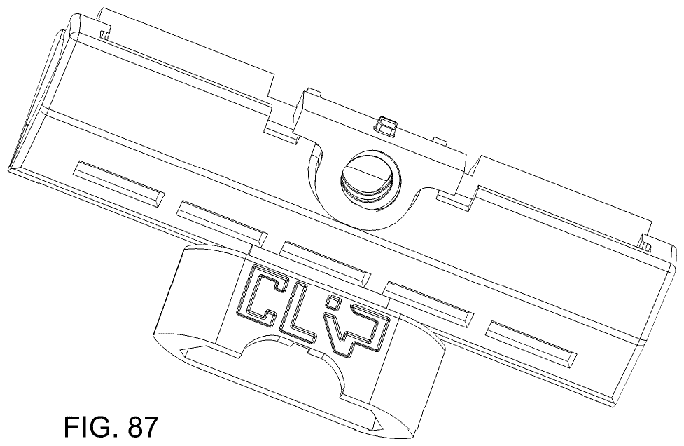

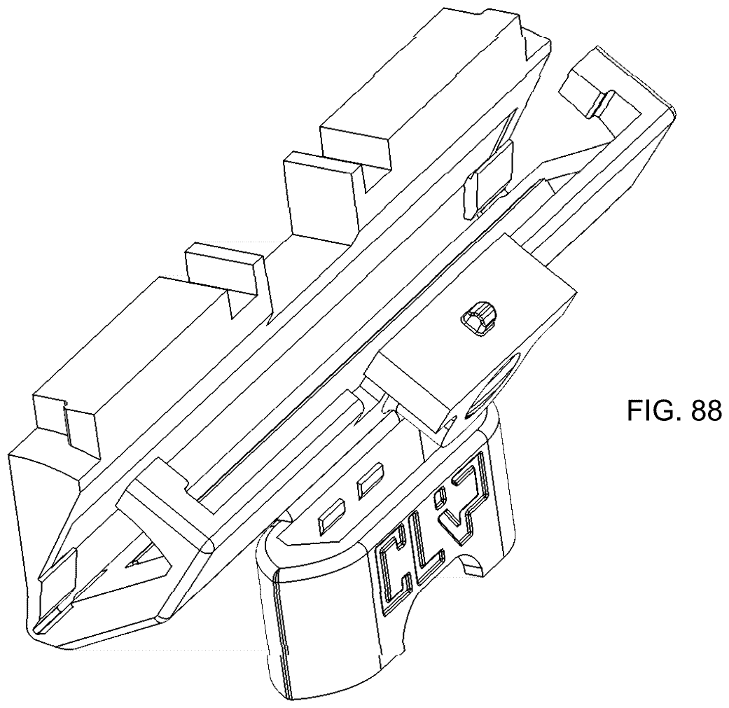

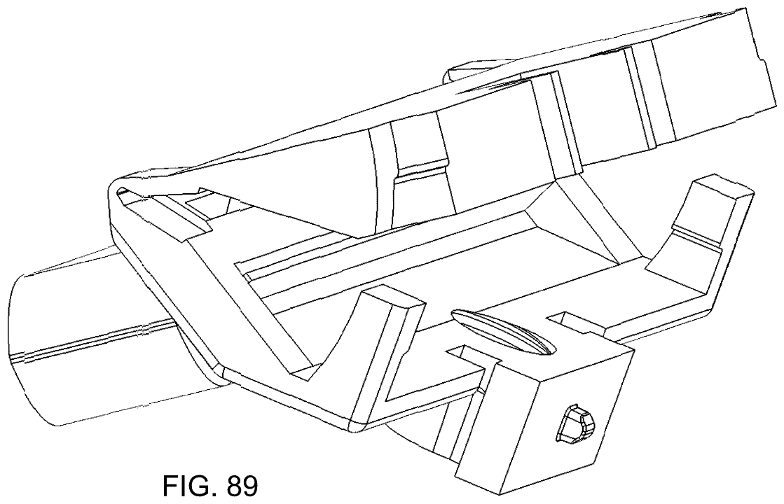

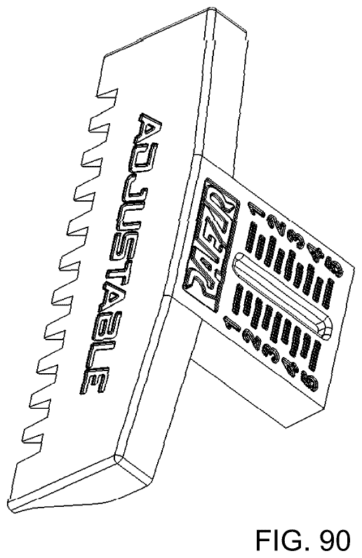

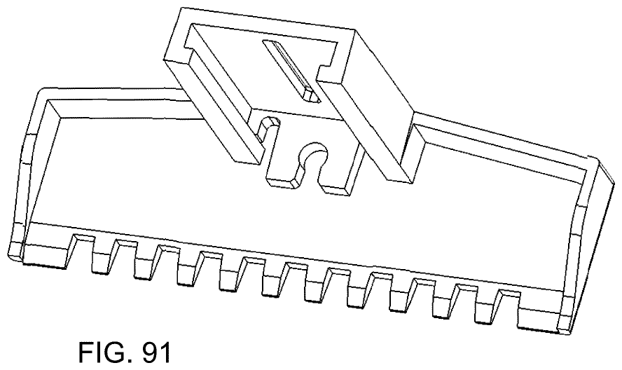

In a fourth non-limiting example, an adjustable hair shaver as depicted in FIGS. 83 through 91 may be described as provided in the following sentences. Depicted in these figures is a version of a plastic, one-blade adjustable razor and razor cartridge. As shown, a consumer may choose the type of razor blade they desire, open a mouth of the housing (as shown in the bottom of FIG. 83, the left side of FIG. 84, the left side of FIG. 85, FIGS. 88 and 89) and insert the razor blade into the housing. Closing the housing around the razor (as shown in the top of FIG. 83, the right side of FIG. 84, the right side of FIG. 85, FIG. 87) results in a cutting edge of the razor being presented on the shaver's surface. Suitably, the shaver's surface presenting the razor edge can include an attachable face guard (shown most directly in FIGS. 90 and 91). Suitably, the face guard may be attached via a screw (FIG. 86) passing through the housing as depicted in FIGS. 83 through 85. As shown in FIG. 90, the adjustable razor may suitably include a scale and a guide hole such that a nub of the housing may be provided thereinto the guide hole and act as a both a scale marker and a guide post. See FIGS. 84 and 85. Suitably, the face guard enables a user to select a length of facial hair resulting after the razor's cutting edge on the surface of the housing is moved along a face protected by the face guard, as disclosed in this specification.

### Example 5

In a third non-limiting example, a hair shaver 100 as depicted in FIGS. 1-69 and 74 through 91 may be described as provided in the following eight sentences.

A body hair shaver comprising:
a one-piece housing configured to hold one or more blade members, the one-piece housing including:
   one or more resilient mouths;
wherein each of the one or more resilient mouths is moveable between an open position for passage of a blade member of the one or more blade members and a closed position for holding the blade member in a hair cutting position.

A body hair shaver comprising:
a one-piece housing configured to hold one or more blade members including:
   a resilient mouth moveable between an open position for passage of the one or more blade members and a closed position for holding the one or more blade members in a hair cutting position.

A body hair shaver comprising:
a one-piece housing including:
   one or more resilient clip members moveable between an open position and a closed position; and one or more slots for holding one or more blade members in a hair cutting position.

A body hair shaver assembly comprising:
a one-piece housing;
a handle; and
one or more blade members;
wherein the one-piece housing includes:
   one or more resilient clip members moveable between an open position and a closed position; and one or more slots for holding one or more blade members in a hair cutting position when the one or more clip members are in a closed position.

A cartridge for a body hair shaver comprising:
a one-piece housing including:
   one or more resilient mouths:
wherein each of the one or more resilient mouths is moveable between an open position for passage of a corresponding blade member and a closed position for holding the corresponding blade member in a hair cutting position.

A razor blade housing for a body hair shaver comprising:
a one-piece member including:
   one or more resilient mouths:
wherein each of the one or more resilient mouths is moveable between an open position for passage of a corresponding razor blade and a closed position for holding the corresponding razor blade in a hair cutting position.

A cartridge for a body hair shaver comprising:
a one-piece housing including:
   one or more resilient clip members moveable between an open position and a closed position; and
   one or more slots for holding one or more blade members in a hair cutting position.

A razor blade housing for a body hair shaver comprising:
a one-piece member including:
   one or more resilient clip members moveable between an open position and a closed position; and one or more slots for holding one or more blade members in a hair cutting position.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

For instance, the embodiments could be metal or plastic. The housing's parts may be cast from molds and, as a result, the housing may be built in multiple pieces since cast metal is sometimes brittle and not flexible unlike plastic. For example, the housing could be divided into a front and back part, and there are separate springs for establishing the housings mouth for receipt of razor blades.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Terms and phrases used in this disclosure, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” “one or a plurality” or the like.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

All original claims submitted with this specification are incorporated by reference in their entirety as if fully set forth herein.

We claim:

1. A body hair shaver (100) comprising:
a one-piece housing (105) that holds a blade member (200), the housing (105) including:
a front portion (107), a rear portion (108), an upper portion (109), a left side portion (110), a right side portion (111), a bottom portion (112) and an angled slot 113) that houses the blade member (200) within the housing (105);
wherein part of the front portion (107) and the rear portion (108) form two blade stops (115, 116) that each have a catch surface (117) operationally configured as abutment surfaces for opposing ends of a cutting edge (210) of the blade member (200) that is housed in the slot (113);
wherein an elongated edge of the front portion (107) and an elongated edge of rear portion (108) disposed between the blade stops (115, 116) face to form an opening (118) there between for receiving part of the cutting edge (210) of the blade member (200) there through;
wherein part of the rear portion (108) of the housing 105 includes at least one clip member (120) operationally configured to be directed between a closed position and an open position:
wherein the clip member (120) is operationally configured to flex or bend in a manner effective to bias the clip member (120) to the open position where the inner surface (121) of the clip member (120) and an inner surface (122) of the housing (105) form a mouth;
wherein whenever the clip member (120) is set to a closed position, the slot (113) suitably includes inner dimensions, e.g., width, length, depth, effective for receiving and holding at least part of the blade member (200) in a snug or close-fitting operable position to produce a desired shave.

2. The body hair shaver of claim 1 wherein the mouth is resilient.

3. A body hair shaver according to claim 1 further comprising:
Wherein the one-piece housing includes the mouth is moveable between an open position for passage of the blade member and a closed position for holding the blade member in a hair cutting position.

4. The body hair shaver of claim 2, wherein the resilient mouth is biased to an open position.

5. The body hair shaver of claim 2, wherein the resilient mouth is configured to lock in a closed position.

6. A body hair shaver comprising:
a housing including:
one or more resilient clip members moveable between an open position and a closed position; and
one or more slots for holding one or more blade members in a hair cutting position.

7. The body hair shaver of claim 6, wherein the housing is one piece and comprises one or more elongated openings in communication with the one or more slots and configured to expose a cutting edge of the one or more blade members.

8. The body hair shaver of claim 6 further comprising a handle coupler and a handle.

9. The body hair shaver of claim 6 wherein the one-piece housing includes a left side and a right side and wherein at least part of the one or more slots are exposed on the left side and right side of the one-piece housing.

10. A body hair shaver assembly comprising:
a housing;
a handle; and
one or more blade members:
wherein the housing includes:
one or more clip members moveable between an open position and a closed position; and
one or more slots for holding one or more blade members in a hair cutting position when the one or more clip members are in a closed position.

11. A cartridge for a body hair shaver of claim 10 comprising:
wherein the housing is a one-piece housing including:
one or more resilient mouths:
wherein each of the one or more resilient mouths is moveable between an open position for passage of a corresponding blade member and a closed position for holding the corresponding blade member in a hair cutting position.

12. A razor blade housing for a body hair shaver of claim 6 comprising:
a one-piece member including:
one or more resilient mouths:
wherein each of the one or more resilient mouths is moveable between an open position for passage of a corresponding razor blade and a closed position for holding the corresponding razor blade in a hair cutting position.

13. A cartridge for a body hair shaver of claim 9 comprising:
a one-piece housing including:
one or more resilient clip members moveable between an open position and a closed position; and
one or more slots for holding one or more blade members in a hair cutting position.

14. A razor blade housing for a body hair shaver of claim 2 comprising:
a one-piece member including:
one or more resilient clip members moveable between an open position and a closed position; and
one or more slots for holding one or more blade members in a hair cutting position.

15. The body hair shaver assembly of claim 10 further comprising a cartridge defined by a one-piece housing including:
one or more resilient clip members moveable between an open position and a closed position; and
one or more slots for holding one or more blade members in a hair cutting position.

16. The body hair shaver assembly of claim 11, wherein the resilient mouth is biased to an open position.

17. The body hair shaver assembly of claim 15, wherein the resilient mouth is configured to lock in a closed position.

18. The body hair shaver of claim 10 and wherein the housing, in a first configuration, is open such that a blade is positioned therein, and where in, the housing, in a second configuration is closed such that the blade is secured therein the housing with a cutting edge exposed at a surface of the housing for cutting hair.
